(19) United States
(12) Patent Application Publication
(10) Pub. No.: US 2004/0255034 A1
(43) Pub. Date: Dec. 16, 2004

(54) Method and apparatus for obtaining personal access information and delivering information in electronic form using the obtained personal access information

(76) Inventor: Jong Hyuk Choi, Yorktown Heights, NY (US)

Correspondence Address: BLACKWELL SANDERS PEPER MARTIN LLP, 720 OLIVE STREET, SUITE 2400, ST. LOUIS, MO, 63101, US

(21) Appl. No.: 10/481,132

(22) PCT Filed: Jun. 18, 2001
(86) PCT No.: PCT/KR01/01039

(51) Int. Cl. G06F 15/16

(52) U.S. Cl. 709/229

(57) ABSTRACT

An information delivery system enabling decoupled delivery of value added more detailed information of a plurality of information presented or represented by geographically distributed electronic information gateways to the unique network access information of customers acquired by those gateways as destinations, wherein the methods of operation is comprised of presentation process wherein the electronic information gateways presents one or a plurality of electronic information in sequence periodically to outside, storage process wherein coupled pairs of the current presentation information identifier and the extracted data from the inbound signal when external signal is sensed during said presentation of electronic information, transmission process wherein said coupled pair of extracted data and the electronic information provision server, and delivery process wherein said electronic information provision server retrieves the network access information of customers from the received data consisting of such pairs and transmits the link or contents of the further information obtained from the said electronic information identifier to the retrieved network access information as destinations, thereby enabling convenient expression and delivery of information acquisition request originated from the advertisement and informative contents located at the physical places and objects and seamless information delivery thereafter, and hence enhancing values of objects and installations having informative and advertising purpose.

### TECHNICAL FIELD

The present invention relates to electronic information delivery apparatus and method that acquire unique identification information of individuals or of handheld communication devices from handheld storage medium and deliver electronic contents and information related to the exposed objects or display using the said acquired identification information as delivery destination address. The invention also relates to storage media containing program executables and/or sources implementing the said method.

### BACKGROUND OF THE INVENTION

Before the Internet, the World Wide Web (WWW), and electronic mails became popular, information, advertisement, and related ordering means were delivered through traditional off-line methods such as traditional media (newspaper, magazine, television), signs, direct mailing, and direct sales.

These off-line information delivery methods, when viewed from the perspective of the providers of contents and the said delivery methods, have the following drawbacks: it is hard to measure their effects, difficult to target customers by their profiles in order to decide contents and provisioning locations, ineffective to provide convenient procedure that leads to customer's reaction and procurement, and impossible to verify such delivery immediately.

From the perspective of customers, the information delivery takes place in a pushing fashion, so that the customers acquire information at the time and the place imposed by the provider of such information. The customers cannot acquire information at desired time and place. Moreover, no means is provided to immediately provide more detailed information when customers request such more detailed information out of the originally delivered information.

In addition, it is usually difficult to freely copy, store, and exchange such delivered information and accordingly difficult to exchange opinions Through information exchange means established among customers. Hence, the said traditional off-line information delivery methods perform only a limited set of functions such as simple information delivery, corporate image recognition, and product information delivery.

Recently, it has become popular to utilize network information exchange means, such as the Internet, WWW, electronic mails, and Usenet, as a novel means of delivery of electronic commerce ordering links and forms as well as conventional information and advertisement.

From the customers' perspective, it is possible to acquire information or buy, sell, and exchange products at customers' desired time and place if customers connect to network and use apparatus and methods that enable customers to acquire information and documents in an electronic form (For ease of description, they will be referred to electronic document from this point on.). It is also possible to request detailed information using hypertext, to plan future acquisitions by utilizing electronic malls and information crawling agents, and to immediately search desired information by using network search engines. From the providers' and sellers' perspective, it becomes easy to measure the effects of electronic document delivery, effective to target advertisement according to customers' profile data, natural to lead to customers' reaction and procurement by linking electronic ordering form to the information and advertisement.

Additionally, it becomes possible to immediately make and commit decisions according to the measured result. Customers can copy, save and store the contents of electronic documents and exchange opinions via electronic information exchange channels among customers. FIG. 1 illustrates a network architecture wherein information is delivered and exchanged. The following description explains prior arts of information acquisition and successive electronic commerce under network architecture such as on illustrated in FIG. 1.

First, customers connect to the network (35) by using portable or stationary information terminals (10). Customers can locate out of the entire network electronic document pages from the search engine server (20) which searches electronic documents and information related to a specific topic or from the electronic document directory server (22) which has classified listings of electronic documents and information.

The search engine server (20) is usually equipped with search database (25) which stores previous search results while the directory server is usually equipped with list database that stores classified results. The information server (50) is providing information on a specific topic, a specific field, governmental organization, personal information, traditional and novel media, and electronic commerce. The said information server is composed of computing server (55) which consists of single or multiple computer systems, information database (60) which stores information to serve, and user database (65) which stores information on users and customers.

The electronic mail information server (90) delivers information on topics and interest fields customers registered, regularly or irregularly via information delivery methods such as the electronic mail. The electronic mail information server (90) includes electronic mailbox database (95) and user database (99). The advertisement server (70) provides target advertisement according to the relevancy to the information to customers and/or to customer's demographic profile and preference, in response to requests from customer information terminal or to requests of information server (50) or electronic mail information server (90). In addition, the advertisement server (70) performs advertisement scheduling, selection and management of advertisement media, advertisement policy establishment and enforcement, and customer and server log analysis. The advertisement server (70) includes computing server (75) which performs and analyze policy decision, advertisement database (80), and user information database (85). The electronic commerce server (11) has higher security features enabling safe transactions with customers. The flow of value is managed by communicating with payment server, banking server, logistics server, and security key server.

FIG. 2a illustrates a general procedure of searching and acquiring information together with related advertisement by utilizing the said customer information terminal in the network architecture of FIG. 1.

First, the customer information terminal (10) transmits (A) the search keyword or field to the search engine (20) or directory server (22). The search engine (20) and the directory server (22), upon or prior to lookup requests, requests (B) and collects (C) information on keywords and fields from the information servers (50) and stores them according to predefined classification.

The search engine (20) and the directory server (22) provide the customer information terminal (10) with a list of electronic documents containing information customers desired to acquire. (D) The information terminal (10) transmits the intention to acquire information (E) to the information server (50) which is located by the unique identifier provided by customers or by the search engine (20) or the directory server (22). The information server (50) transmits electronic information or documents the customer information terminal (10) requested to the customer information terminal. (F) At the same time, the information server (50) transmits meta information on the information that it transmits to the customer information terminal (10) and on the customer to local or remote advertisement server (70). (G) The advertisement server (70) selects the most matching and effective advertisements and transmits them to the customer information terminal (10) in order to maximize advertisement effects. (H)

In order to acquire and store information on customers, it is usual to provide the customer registration server (24) with the customer profile and preference information and statistics data and to register them (A), before the customer information terminal (10) transmits the intention to access information to the information server (50). The customer registration server (24) provides the customer information terminal (10) with cookies that represent a valid membership status as a user in the registration server. (D) When the above customer registration is required for information search and access, the customer registration server (24) asks the information server (50) to acquire information (B) after the registration process.

FIG. 2b illustrates a general procedure of acquiring electronic documents delivered to the customer information terminal (10) in a form of electronic mails in the network architecture of FIG. 1.

The customer information terminal (10) registers customers to the registration server as users (24) by sending customers' profile and preference data, statistics data, and the types of information they want to acquire. The customer registration server (24), then, sends response back (C) to the information terminal (10), provides the electronic mail information server (90) with the customer identity information and the intention to acquire electronic information and documents via electronic mail. (B) The electronic mail server (90) transmits the electronic document customers want to acquire to the information terminal (10) at least once, regularly or irregularly. (D) While transmitting the electronic document, the advertisement server (70) provides matching advertisement (F) to the information terminal (10) targeting customers according to the area of the document or customer information delivered from the electronic mail information server to the advertisement server (E).

The prior methods of acquiring and delivering information and electronic documents by using various network information and communication methods illustrated in FIG. 1, FIG. 2a, and FIG. 2b, enables any customers to search and acquire information and electronic documents without the restriction of time and distance, and moreover, enables procurement of product and value exchanges by using electronic commerce through network information and communication methods. As a result, they are creating limitless possibilities and values. In addition, information delivery, advertisement, and electronic commerce Through portable information communication methods makes customers access network during move. The information and advertisement delivery Through information communication means makes the entire process of search, acquisition intention, delivery, acquisition, and procurement seamlessly and conveniently succeed in the World Wide Web, UseNet, electronic mails, and mailing list inside the cyberspace.

However, customers consume most of their time in the physical real space, as opposed to the cyberspace, even if they consume a lot of time in the cyberspace. They do most of the works in the real space, meet many more people in real space than in cyberspace, and move to a remote location by using a transportation means in the real space. They live most of their lives in the physical real space. Hence, they acquire most of information and advertisement in the physical real space and buy, sell, and exchange most of products and values therein.

Customers who are exposed to information and advertisement in the real space and buy products and services have contacts to such information, advertisement, and order form in various types of media: print and broadcasting such as newspaper, magazine, television; off-line information and documents such as direct mailing, information and advertisement signs, installations, and billboards; and products and goods themselves. In particular, when customers move on foot or by transportation means, and when customers are staying at public places or commercial district's, they are exposed to information and advertisement signs, installations, billboards, products, and architectures, and recognize their contents. Examples of such information and advertisement sign, installation, and billboard include information and advertisement signs inside public transportation means such as subways (metro) and bus, billboards and signs on the street, signs and list of products and services of stores, exhibits of industrial and cultural exhibitions, explanatory installations at museums, concert halls, public parks, and zoos, public billboards, sales installations of printed media such as newspapers and magazines, products themselves, architecture, and miscellaneous facilities.

These off-line methods of information, advertisement, order form delivery are still very important despite the explosion of online information acquisition and delivery methods, because customers are still acquiring much information, advertisement, and order from information sources in the physical real space. According to “Advertising on the Internet” by Robbin Zeff (publisher: John Wiley & Sons), only 1% of total advertisement was delivered to the networked cyberspace, while the rest 99% is still delivered to the off-line information and advertisement delivery media including most of the traditional media.

The effect of online information and advertisement delivered in the cyber space is usually less than the effect of off-line information and advertisement. Usually, when customers are exposed to the online information and advertisement, they are doing other task on business or privately, On the other hand, off-line information and advertisement delivered in the real space are targeting customer's spare time by attracting customer's attention while he or she is on move or waiting in the line. This is advantageous because customers are exposed to the information and advertisement on products and service without much interruption and intrusion. Because customers does much of their activity in the physical real world and there exist significant discrepancy in characteristics between the information acquisition method in the cyberspace and that in the real space, the significance, importance, and volume of offline information and advertisement in the real space will not shrink, despite the expanding use of online information and advertisement delivery in the cyberspace. The volume of such off-line information and advertisement will grow on the contrary.

Nevertheless, the offline information and advertisement signs do not have many advantages and services online information acquisition and delivery method provide: acquisition and delivery at desired time and place, immediate and interactive delivery of more detailed information on demand, immediate save and store of electronic documents, opinion exchange channel among customers, targeting by differentiation, measuring effects of targeting, leading to product purchase via electronic commerce, prompt decision making of electronic document delivery. Lacking these advanced features, the off-line information and advertisement have not been considered highly effective in linking exposure to actual purchase, and hence revenue growth. As a result, the offline information and advertisement signs function as a primitive and simple means of information and advertisement delivery whose value and role are decreasingly significant.

Recently, hybrid information and advertisement delivery methods and apparatus such as the Cooltown framework of Hewlett Packard Corp. have been proposed to provide links between off-line information signs and advertisement and online network access information. The said cooltown extends the acquisition methods of electronic documents in the cyberspace to off-line real world by utilizing difference between the physical space and the cyberspace. In other words, the network access information is attached to objects exposed in physical places so as to acquire more detailed information by utilizing the said network access information. The model of information flow is illustrated in FIG. 3. The cooltown information system consists of portable information device (2) such as PDAs and cellular phones which can connect to network by wire or wirelessly and can receive infrared or radio wave beacon signal and infrared or radio wave beacon device (3) which transmits network access information such as URLs while attached to objects exposed in the physical places. The beacon device can optionally acquire content information on the objects it is attached to.

Within such cooltown system, customers can collect URL information beacon devices transmit by using portable devices such as PDAs and cellular phones, when the customers have intention to acquire more detailed information on real world objects. If the said portable device is equipped with wireless networking function, the customers can access the information immediately by using the wireless networking. Otherwise, customers should synchronize or download such collected URLs to computer terminals in places possibly different from the place the URL is collected in order to access the corresponding web page using the said computer terminal (4).

However, in the said information and advertisement delivery methods and apparatus such as the cooltown system, URL information is transmitted from the beacon device to the portable information device. Hence the portable device should be equipped with the means of reception and interpretation of infrared or radio wave signals transrmitted from the beacon devices in addition to the general computing means such as in PDAs and cellular phones. As a result, those portable devices used in the said information and advertisement delivery methods are expensive. Because customers should carry those expensive information devices, it is difficult to deploy and disseminate the pervasive information linking system and service.

### DISCLOSURE OF THE INVENTION

Generally, the present invention provides an apparatus, methods, and media containing programs that implement the method in order to facilitate the pervasive information delivery and to overcome shortcomings of prior arts. The present invention provides an electronic information delivery apparatus that acquires from the portable storage media the unique address identifier by which the customer is identified uniquely in an information network or the unique identifier of information devices via distributed terminals via distributed terminals in order to electronically deliver more detailed information contents and/or links to the customer; a electronic information delivery method using the said electronic information delivery apparatus; and storage media containing the program implementing embodiments of the said information delivery methods.

In order to achieve the above objectives, one embodiment of the apparatus of the present invention provides a electronic information gateway apparatus which consists of a communication means that exchanges data with other devices; a storage means that stores identification information of the object for the network server to uniquely identify the object that is exposed to the customers in the physical real places; a signal reception means that receives signals from the portable storage means and extracts customer identification data a control means that associates the identification information that is extracted from the said portable storage means and the identification information that is stored in the said storage means as a pair to transmit it to external servers or clients.

Another embodiment of the present invention provides an electronic information gateway apparatus that consists of a communication means that exchanges data with other devices; a storage means that stores electronic information on the exposed object which is received by the said communication means and that stores identifiers that designate the identity of the said electronic information; a display means that converts and outputs the said electronic information in a human understandable form; a signal reception means that receives signals from the portable storage means and extracts customer identification data; a control means that associates the identification information that is extracted from the said portable storage means and the identification information that is stored in the said storage means as a pair to transmit it to external servers or clients, in order to achieve the above objectives.

In another embodiment of the present invention, a electronic information gateway apparatus consisting of a communication means that exchanges data with other devices; a storage means that stores electronic information on the exposed object, that stores identifiers that designate the identity of the said electronic information, and that stores a unique identifier of the said exposed objects in the physical real space; a display means that converts and outputs the said electronic information in a human understandable form; a signal reception means that receives signals from the portable storage means and extracts customer identification data; a control means that associates the identification information that is extracted from the said portable storage means and one or all of the identification information of the electronic information that is being displayed in the said display means and the identification information of the objects the said electronic information is about, in order to achieve the said objective.

One embodiment of the present invention provides a electronic information provider apparatus that consists of one or more of the said electronic information gateway that outputs stored electronic information in a human understandable form and transmits the customer identification data received from proximity or contact type portable storage means together with the identifier of the electronic information which is being displayed at the time onto the interconnected network means; and a electronic information server means that receives the pair of the said customer identification data and the said electronic information identification data via the said network, extracts the network access information of the customer from the said customer identification data, transmits more detailed information of the electronic information which is addressed by the said electronic information identification information to the said network access information as destinations, in order to achieve the said objective.

One embodiment of the present invention that achieves the said objective provides a customer identification acquisition and an electronic information delivery method using the acquired identification information which consists of the following steps of activities of the information gateway: (a1) receiving signals from the portable storage means and extracting data when the network server that provides more detailed information on the objects exposed to the real physical places stores the unique identifier of the said objects, (a2) establishing the message containing the said object identification information by acquiring the customer identifier from the extracted data; and (a3) transmitting the said message to the said network access information as the destination.

In another embodiment for the present invention to achieve the said object, a customer identification acquisition and an electronic information delivery method using the acquired identification information which consists of the following steps is provided: (b1) the information gateway receives signals from the portable storage means and extracting data when the network server that provides more detailed information on the objects exposed to the real physical places stores the unique identifier of the said objects; (b2) the information gateway composes the message containing the said object identification information and the customer identifier from the extracted data; (b3) the information gateway transmits the said message to the information provider server as the destination which provides more detailed information on the said object; (b4) the information provider server receives the said message and to transmit more detailed information to the said network access information as the destination.

In another embodiment for the present invention to achieve the said objective, a customer identification acquisition and an electronic information delivery method using the acquired identification information which consists of the following steps of the information gateway device is provided: (c1) storing plurality of electronic information to be displayed to outside and storing its identifier which are received via the said communication means; (c2) the concurrent operation of displaying the said plurality of electronic information by rotating them with a predefined period or interval and of checking and receiving the signal reception from the said portable storage means and extracting data; (c3) composing messages containing the customer identification and network access information from the extracted data and the identifier of the electronic information which was displayed at the time of customer interaction through proximity or contact activity; (c4) transmitting the said message to the said network access information as the destination. In another embodiment for the present invention to achieve the said objective, a customer identification acquisition and an electronic information delivery method using the acquired identification information which consists of the following steps is provided: (d1) the information gateway stores plurality of electronic information to be displayed to outside and storing its identity which are received via the said communication means; (d2) the information gateway performs the concurrent operation of displaying the said plurality of electronic information by rotating them with a predefined period or interval and of checking and receiving the signal reception from the said portable storage means and extracting data; (d3) the information gateway composes messages containing the customer identification and network access information from the extracted data and the identifier of the electronic information which was displayed at the time of customer interaction through proximity or contact activity; (d4) the information gateway transmits the said message to the information provider server as the destination which provides more detailed information on the said object; (d5) the information provider server receives the said message and to transmit more detailed information to the said network access information as the destination.

In another embodiment for the present invention to achieve the said objective, a customer identification acquisition and an electronic information delivery method using the acquired identification information which consists of the following steps is provided: (e1) the information provider server storing plurality of electronic information and their identifiers transmits all or selected set of electronic information and their identifiers to one or more electronic information gateways; (e2) the said electronic information gateway receives the transmitted electronic information and identifiers and displays one or more such electronic information to outside by rotating them periodically; (e3) concurrently with the said display step, the said electronic information gateway extracts customer identification data from the received signal from the said portable storage media and stores the identification data together with the identification data of the electronic information displayed at the time of customer interaction Through proximity or contact activity; (e4) the information gateway transmits the said stored pairs of customer and electronic information identifiers to the information provider server; (e5) the information provider server receives the said identifier pairs, acquires the customers' network access information and acquires more detailed information on the said object by searching it from the electronic information identifier; (e6) the information provider server transmits the more detailed information to the acquired network access information as the destinations.

The following texts of the present invention disclosure provides detailed description of the information gateway and the information provider server apparatus, the method of information delivery using them, and the storage media containing the program incarnating the method of information delivery, by presenting preferred embodiments with detailed illustrations via figures to facilitate easy understanding of the present invention.

The description of the electronic information gateway and the electronic information delivery method using the gateway provided in the present invention is based on a class of information gateways that have display means that outputs electronic information for the sake of convenient description. The description of the said computer program realizing the information delivery method of the present invention assumes a program environment under the wired or wireless communication network interconnecting server computers in preferred embodiments. Certainly, gateways that do not have electronic information and the said display means are also included in the preferred embodiments of the present invention that shall be described in the following text. The main technical idea behind the preferred embodiments presented in the present invention disclosure is not restricted nor limited to them and shall also be practiced in various forms, incarnations, and embodiments.

In addition, the preferred embodiments of the present invention include computer systems that are programmed to perform the method provided in the present invention as well as such computer programs. In the preferred embodiments implemented with computer programs, the sequence of instructions of the computer program that implements the said electronic information delivery methods resides in one ore more memory (RAM, ROM) or can be stored as a computer program product or image inside secondary computer memory, such as disk drives or other media, until the computer program requires it to execute to implement the said information delivery method.

### BRIEF DESCRIPTION OF THE DRAWINGS

FIG. 1 illustrates the network architecture and interconnection for the delivery of electronic documents such as information, advertisement, and order forms via communication networks such as the Internet.

FIG. 2a illustrates the search and delivery method based on the Web and the hypertext transfer protocol (HTTP) in the network architectures as shown in FIG. 1.

FIG. 2b illustrates the method of expressing customer's intention to acquire information, advertisement, and order forms and the method of their delivery by using electronic mails in the network architecture as shown in FIG. 1.

FIG. 3 illustrates the information flows and methods of prior arts (such as those of the cooltown system) that provide a means to link off-line objects in the physical places to online network access information on the off-line objects.

FIG. 4 illustrates the architecture of electronic information delivery network according to one embodiment of the present invention that uses the active-independent information gateway.

FIG. 5 illustrates the architecture of the said active-independent information gateway which delivers information, advertisement, and order forms, according to the preferred embodiments of the present invention.

FIG. 6 illustrates in an integrated way the hardware and software architecture of the information provider server according to the preferred embodiments of the present invention.

FIG. 7 illustrates the architecture of the proximity and contactless storage apparatus, such as the contactless smartcard and tag, which is used to express intention to acquire information at the information gateway according to the preferred embodiments of the present invention.

FIG. 8a and FIG. 8b illustrate contact type storage apparatus, such as the smartcard and the tag, which is used to express intention to acquire information at the information gateway according to the preferred embodiments of the present invention.

FIG. 9 illustrates signal reception means of electronic information gateway illustrated in FIG. 5 in detail, which communicates with contact-type portable storage media.

FIG. 10 illustrates bio informatics signal reception means that identifies customer's identify using the customer's bio information, such as fingerprint and iris image.

FIG. 11 illustrates one embodiment of network architecture in which detailed electronic information is delivered to the extracted customer access address by using the active-dependent information gateway.

FIG. 12 illustrates one embodiment of the passive electronic information gateway that transmits identifier of electronic information to customer's portable device.

FIG. 13 illustrates one embodiment of network architecture in which detailed electronic information is delivered to the extracted customer access address by using the passive information gateway.

FIG. 14a and FIG. 14b illustrate signal transceiver means of FIG. 12 for proximity and contact-type signal transmission.

FIG. 15 illustrates one embodiment of portable communication device that receives and stores identifiers of electronic information and that transmits the said identifier together with the customer's network access information to the information provider server.

FIG. 16 illustrates one embodiment of the integrated network architecture that comprises of various types of information gateways and of various types of interconnection methods, to deliver electronic information by using acquired customer network access information according to the present invention.

FIG. 17, FIG. 18, FIG. 19, and FIG. 20 illustrate different embodiments of installations of the information gateways of the present invention and their physical spaces and dimensions.

FIG. 21a, FIG. 21b and FIG. 21c illustrate one embodiment of the method provided by the present invention in which the information gateway equipped with the display means transmits message directly to customers.

FIG. 22a, FIG. 22b, and FIG. 22c illustrate one embodiment of the method provided by the present invention in which the information gateway not equipped with the display means transmits message directly to customers.

FIG. 23a, FIG. 23b, FIG. 23c, and FIG. 23d illustrate one embodiment of the method provided by the present invention in which the information gateway equipped with the display means transmits message to the information provider server. FIG. 24a, FIG. 24b, FIG. 24c, and FIG. 24d illustrate one embodiment of the method provided by the present invention in which the information gateway not equipped with the display means transmits message to the information provider server.

FIG. 25a, FIG. 25b, and FIG. 25c illustrate one embodiment of the method provided by the present invention in which the information provider server transmit message to the customers.

FIG. 26a, FIG. 26b, and FIG. 26c illustrate one embodiment of the method provided by the present invention in which the customer acquires link data by logging in to the information provider server.

FIG. 26d, FIG. 26e, FIG. 26f, and FIG. 26g illustrate one embodiment of the method provided by the present invention in which the customer acquires content data by logging in to the information provider server.

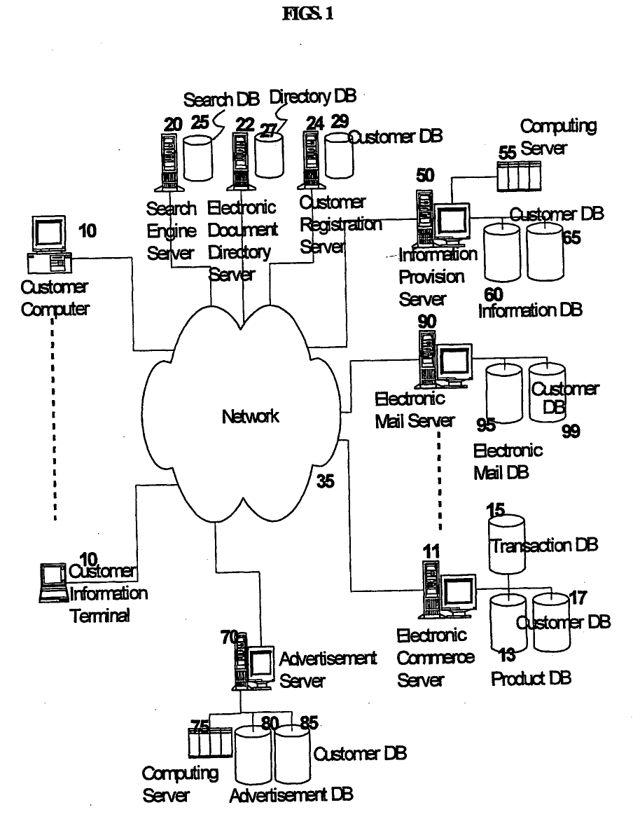

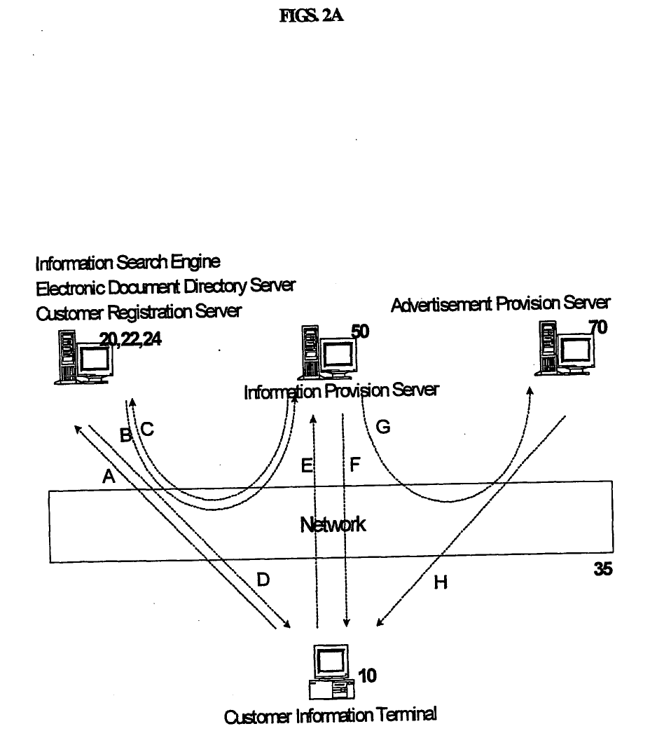

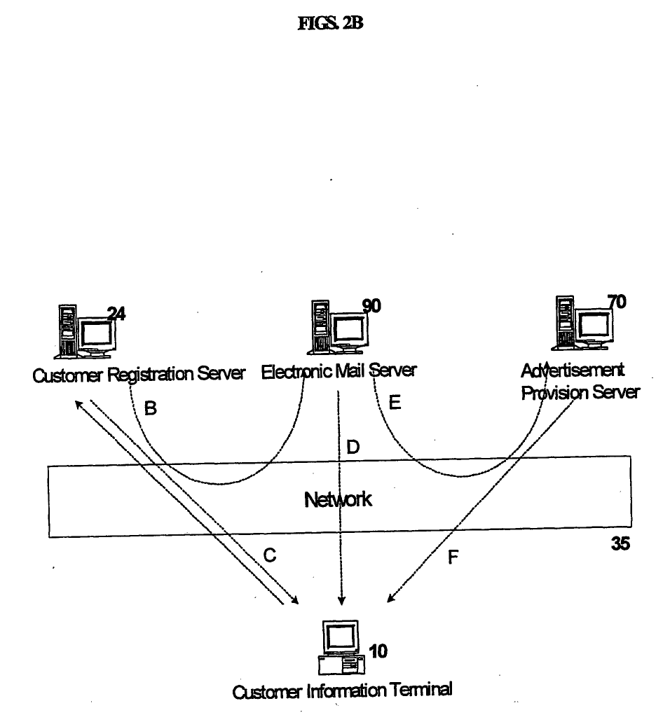

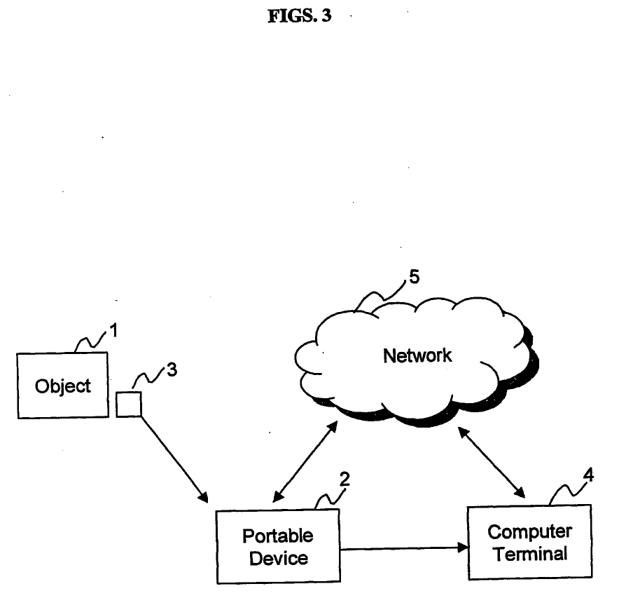

### PREFERRED EMBODIMENT OF THE PRESENT INVENTION

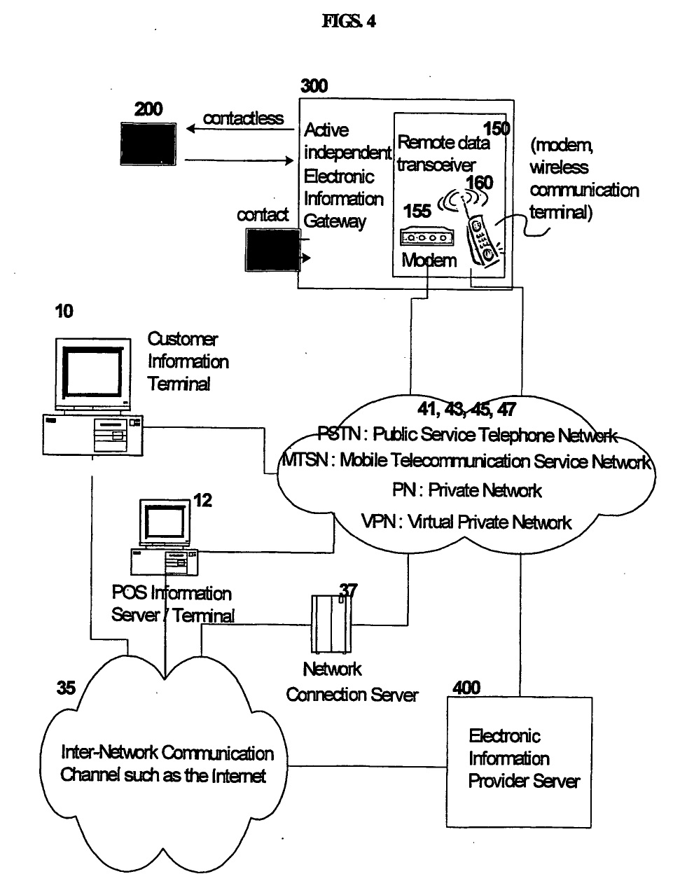

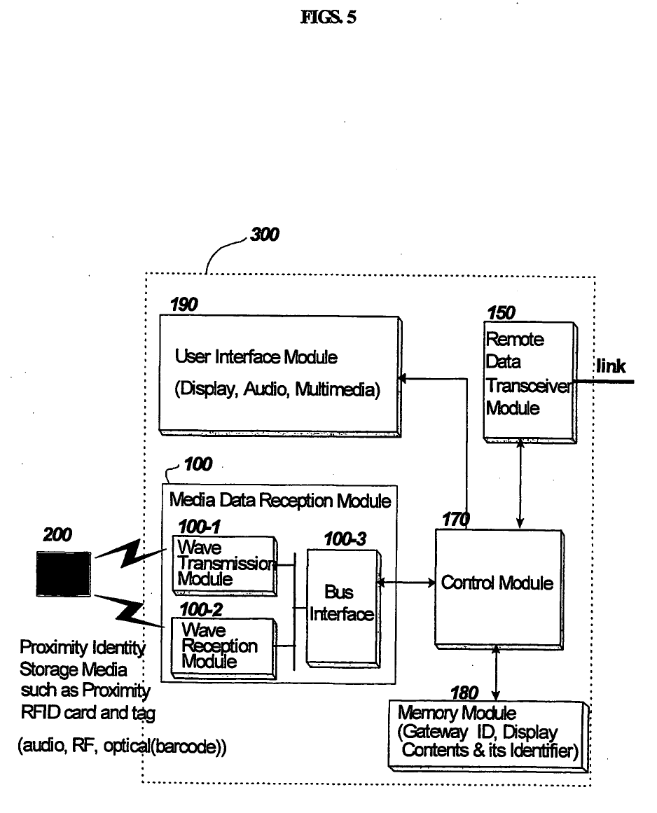

In FIG. 4, one embodiment of system and network that provide the acquisition of customer network access information and the means of information delivery to the acquired access information by using the active-independent electronic information gateway provided by the present invention.

In the embodiment shown in FIG. 4, the customer expresses his or her intention to acquire electronic information by put the ID card or tag (200) in close proximity to or in contact to the electronic information gateway (300), so that said information gateway (300) reads and stores the network access information of the customer, such as customer's II) or electronic mail address. Said fl) card can be realized by smartcards functioning as portable contact-type storage means or proximity storage means, such as IC cards or RE cards. These storage means can certainly be realized in a form of sticker, label, and pendant that can be attached to customer's personal effects.

The following descriptions of embodiments provided by the present invention take the cards and tags as examples for the sake of convenient description; the general idea of the present invention is not limited or restricted by the form factors or physical shape of the portable storage means. In the case of proximity type storage means, the signal reception means of one embodiment of the present invention use radio frequency signal, magnetic field, electric field, or optical code reading methods to read information stored in the cards and tags, while in the case of contact type storage means, said signal reception means uses electric or magnetic contact to read information stored in the cards and tags.

The said electronic information gateway (300) creates list of information designating which customer expressed intention to get which information or advertisement it is outputting to the customer. The gateway transmits this list of information either to the information provider server (400) or directly to the network access information of the customer. The gateway creates the list by saving the network access information of the customer, coupled with the identifier such as ID or the uniform resource locator (URL)-unique and uniform address information consisting of protocol, host name, domain name, and path (e.g. http:/hostname.domainname/path)—which identifies online electronic information representing or related to the contents presented using output means of plurality of media types or representing or related to off-line objects (exposed in the physical real space to unspecified number of people in daily life; with or without substance) when no multimedia display means is provided.

The said electronic information identifier can be a combination of one or more of the following: an identifier number or string that represent one or more electronic information, name or ID of the provider of the electronic information, and the network (Internet) address of one or more servers that delivers the information in an electronic form.

FIG. 4 illustrates one embodiment of the present invention in which individual information gateway (300) is performing the information transmission as well as reading customer address information from the cards or tags. The gateway transmits the customer access information and the identifier to center server (400) or directly to network access address.

After describing the architecture of the information gateway and storage media such as cards in more detail, the present invention disclosure describes the methods of electronic information acquisition and delivery of detailed information to customers by using the acquired information in more detail. FIG. 5 illustrates in detail one embodiment of the electronic information gateway which is comprised of media signal reception means (100) which reads information stored in cards and tags, memory storage means (180), such as memory or secondary storage (hard disk, disk driver device) which stores information on objects exposed in physical real space, ID of gateways, information acquired by the media signal reception means (100), remote data transceiver means (150) which connects to network (wired or wireless network or the Internet; e.g. the public service telephone network (PSTN), the mobile telecommunication service network (MTSN), and the virtual private network (VPN)) in order to exchange data with remote central server (400), control means (170) which controls data flow among all such means of the gateway and operations of such means, wherein said media signal reception means (100) is comprised of signal transmitter (100-1) which transmits audio, optical, or radio signal to enable data output operation of storage media such as cards and tags, signal receiver (100-2) which receives signals or waves from the said storage media and demodulate them, interface means (100-3) which relays data to and from the said signal transmitter (100-1) and the said signal receiver (100-2), respectively, via the internal bus of the information gateway for the said control means (180) to access the data. In particular, it is desirable to have additional user interface means (190) that outputs electronic information, when said information gateway of FIG. 5 has plurality of electronic information, wherein said memory storage means (180) is organized in a way that stores together the gateway ID, data acquired by the media signal reception means (100), output electronic information via said user interface means (190).

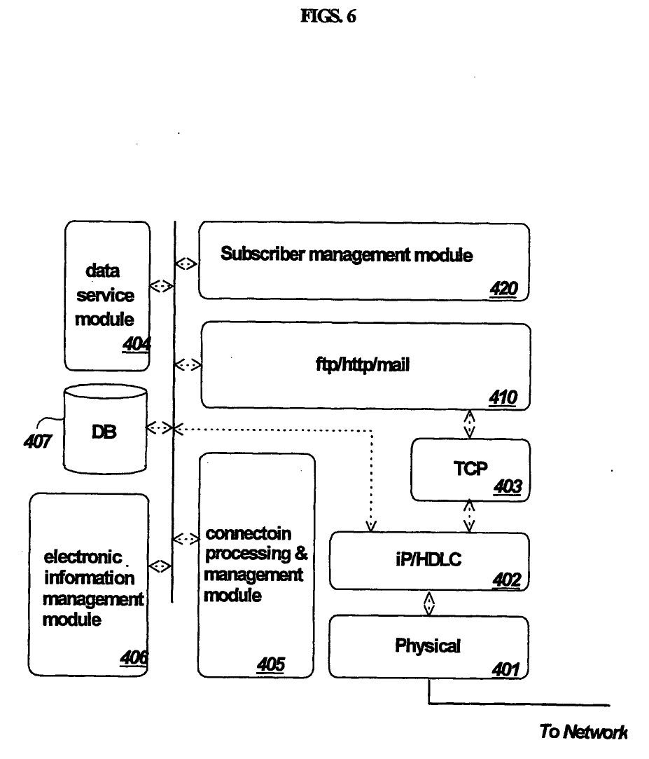

FIG. 6 illustrates one embodiment of hardware and software architecture of the electronic information provision server (400) of the present invention, which is comprised of network access module (401) which exchanges data signal via networked links, data link module (402) which communicates with the network device of the other end of the connection by exchanging packetizes data frames with a fixed maximum length and with sequence numbers, packet data module (403) which performs the encapsulation and decapsulation of packets in association with the network device of the other end of the connection, application protocol module (410) which transmits and receives data in one of the forms of file, hypertext, or electronic mail based on the said exchanged packet data, data service module (404) which searches and provides information in one of the forms of character, file, or hypertext through the said application protocol module (410), data storage module (407) which stores various electronic information such as advertisement and announcement and other types of value added electronic information which are to be delivered to the said electronic information gateway equipped with information presentation means, electronic information management and control module (406) which provides electronic information to said electronic information gateway and processes and responds to successive request to additional information, customer or subscriber management and control module (420) which provides information on them online or offline, processes subscription requests, and manages profile or network access information (the customer or subscriber management and control module can reside in the electronic information provision server), and connection processing and management module (405) which process connection requests from network and controls protocol data flow among said modules in order to respond to service requests.

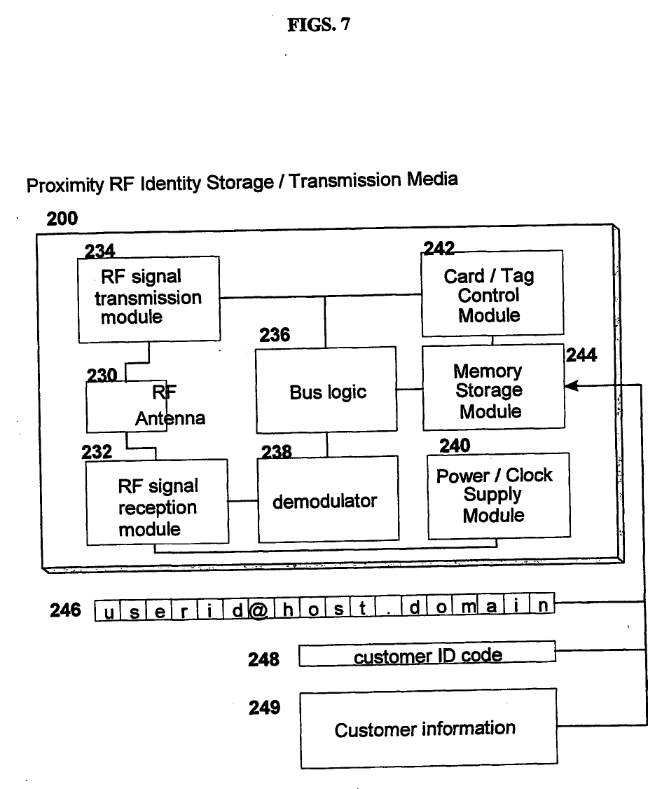

FIG. 7 illustrates one embodiment of proximity (contactless) smartcard (200) which is used at the said electronic information gateway apparatus to express intention to acquire further information, which is comprised of RE (radio frequency) signal reception module (232) which receives via antennas (230) or other types of sensors audio, optical, and RE signal transmitted from the electronic information gateway (300), power and clock supply module (240) which generates power and clock from the said RE signal reception means (232) and stabilizes the power and clock by utilizing the phase locked loop (PLL), demodulator module (238) which demodulates received RE signal from the said RE signal reception module (232), card and tag control module (242) which controls signal exchange with external device and controls internal data flow between various modules, bus module (236) which provides data and address movement path among various modules, RE signal transmission module (234) which transmits data, stored in the storage memory module (244) and read by said bus module, to said electronic information gateway (300) through antenna in an RE modulated form, wherein said storage memory module (244) stores as data the network access information of customers that own smartcards and/or tags such as electronic mail address (246), the personal identification number (248) such as social security number and passport number, one or more payment information for billing (plurality of payment information can be secured by different pre-assigned security keys), and miscellaneous personal information such as name and address (249) (in the rest of the present invention description, all such personal information will be referred to as customer identifier or customer identification information, for ease of description).

In one embodiment of the present invention wherein smartcards or tags do not store direct network access information of customers such as electronic mail address, said electronic information provision gateway acquires customer's II) and direct network access information by separate customer registration process by using the said online data service module (404) or by using electronic information gateway, transmits these acquired information to the said customer/subscriber management module (420), and builds and manages subscribed customer information database within the said data storage module (407). The said subscriber database can be provided in the said electronic information provision server as necessary, wherein said build and management of said subscriber database are carried out by the customer/subscriber management module of the said electronic information provision server.

In one embodiment of the present invention wherein the said electronic information gateway has one or plurality of electronic information that is to be presented to outside, electronic information gateway of FIG. 5 retrieves electronic information such as advertisements, or contents from the memory storage module (180) with the control of the said control module (170) and presents them to user interface module (190), wherein the presentation format can be image, video, text, audio, and multimedia—the combination of multiple media—format depending on types of contents. In another embodiment of the present invention wherein the said electronic information gateway does not have presentation means, the object which is represented by electronic information gateway apparatus is assigned the unique identification information that identifies the object or information that represent the object uniquely in networks or the information contents on the object in the memory storage module. Such identification or content information can be transmitted from the electronic information provision server (400) to electronic information gateway (300) via network (41, 43, 45, 47), network access service server (37), and inter-network such as the Internet (35).

In more detail, the connection processing and management module (405) of the said electronic information provision server (400) or the control module (170) of the said electronic information gateway make a connection request through network, initiates said application protocol modules (410) of each end, said electronic information management module (406) selects one or more electronic information from those stored in the said data storage module (407), retrieves their content and identification information, transmits to the said electronic information gateway (300) in a packetized frame unit via lower layer packet data module (403), data link module (402), and network access module (401) according to the file transfer mode of said initiated application protocol modules (410). The electronic information gateway (300) receives the electronic information and identifier via remote data transceiver (150), restructures the received packet data under the control of the said control module (170), and stored to the said memory storage module in a file format according to information types.

Said control module (170) records identification information of the electronic information that is being presented by rotating plurality of electronic information periodically when there are plurality of electronic information such as advertisement stored in said memory storage module (180), and transmits signal waves with a signal strength that reaches a bounded distance from the wave transmission unit (100-1) by sending control data to the bus interface (100-3) in the media information reception module (100).

In one embodiment of the present invention, wherein customer ID cards and tags stores information using patterns such barcodes, said wave transmission module (100-1) transmits optical waves such as laser beam instead of RE waves and acquires customer identifier by receiving reflected optical waves from such cards and tags.

While signal waves are being transmitted for information sensing from ID cards and tags, customers on move recognizes visually or auditorily said electronic information such as advertisement presented by said electronic information gateway (300) or recognizes visually or auditorily objects exposed in real physical spaces (materially or immaterially) and approaches customer's ID cards or tags to said electronic information gateway (300) within a certain distance in order to express intention to acquire more detailed and value added version of said electronic information or of said objects, e.g. contents including product specification, product order form, service order form, or discount coupon. RE reception module (232) of the card or tag, then, receives signal waves transmitted by said wave transmission module (100-1), transforms them to electrical signal, and provides the signal to demodulator module (238) and to clock and power supply modules (240).

Said clock and power supply modules (240) obtain electrical energy from the received signal wave in order to supply energy to each component in the card or tag and obtain synchronization signal from the received signal wave in order to generate stable clocking. Said demodulator (238) demodulates data signal transmitted from the electronic information gateway (300) by using clocks synchronized to the received data signal and sends the demodulated signal to the said control module (242) of cards and tags via said bus module (236). Said card and tag control module (242) senses whether the electronic information gateway apparatus and portable storage media such as cards and tags are compatible or interoperable to each other. If they turn out to be compatible and interoperable, the control module (242) reads customer identification information (246, 248, 249) stored in memory storage module (24) through said bus module (238) and sends the information in sequence to RE transmission module (234) following the said synchronized clock signal. Said RF transmission module (234) transmits inbound data by transforming it to audio waves or to radio waves.

Said waves transmitted as such are received by wave reception module (100-2) of the electronic information gateway (300), demodulated to extract data information in it, delivered to the control module (170) via bus interface module (100-3). By this process, said control module (170) stores the received customer identification information together coupled with the identifier of the electronic information presented by user interface module (190) at the time of customer contact or with the identifier of physical objects as a single entry in the said memory storage module (180).

After said electronic information gateway (300) reads customer identification information from cards and tags according to the said method, said control module (170) makes mutual data path by requesting to the connection processing and management module (405) of the electronic information provision server (400) through the operation of remote data exchange module (150) under the control of said control module (170), if the stored entries in the memory storage module exceeds in number a certain limit, if there is any entry in the memory storage module at periodic checkpoints, or immediately after reading the customer identification information. The said mutual data path between said remote data exchange module (150) and said electronic information server (400) is either through one single communication network (41, 43, 45, or 47) or through global inter-network (35) such as the Internet relayed and routed by network access server (37) after connection according to connection configuration condition.

The connection processing and management module (405) of the said electronic information provision server (400) informs the electronic information management module (406) of the connection establishment with said electronic information gateway. After connection establishment, the said electronic information gateway (300) transmits entry data consisting of customer identification information and electronic information identifier to the said electronic information provision server (400), when said electronic information management module (406) announces to the data link module (402) that it is ready to receive electronic information request entries. Alternatively, said electronic information gateway (300) can directly transmit the identifier or contents of the electronic information to said customer identification and access information as the destination. In this case, identifier or contents will be transmitted to the network address of the customer directly. Said electronic information gateway can optionally transmit its device ID stored in the memory storage module (180) when it transmits said stored entries. Instead of said direct entry upload methods by the electronic information gateway (300), the electronic information management module (406) of the said electronic information provision server (400) requests the transmission of the list of entries stored in the electronic information gateway (300) to receive them after connection is made to the gateway via communication networks (41, 43, 45, or 47), periodically or when administrator or a certain privileged user makes further request on Web pages provided by the data service module (404) on top of the application protocol module (410), packet data module (404), and application protocol module (410).

In one embodiment of the present invention, said electronic information management module (406) stores the customer identification information and electronic information identifier collected from plurality of electronic information gateways (300) by using the said method, retrieves further, more detailed information from said data storage module (407) in a form of link or contents, and directs the said application protocol module (410) to transmit the information to the customer by using network access information of the customer as the destination through messaging systems such as the electronic mail or short messaging service (SMS). When the more detailed information in contents form is not stored in the data storage module (407) of the electronic information provision server, such information is retrieved from other servers connected to network such as the Internet so as to be forwarded to the customer network address in electronic mail or in short message forms, it is true that the customer can also directly access collected links or contents in the electronic information provision server by logging into the server and read such entries, instead of receiving electronic mail or short message delivery.

Such further information delivered to the customer includes more detailed and complimentary information of the content directly presented by the electronic information gateway. In addition, such further information includes value added information such as cyber money in circulation in electronic commerce and electronic discount coupon or its identifier, in order to give rewards to customers for reception of the advertisement and informational contents.

In case that extracted customer information includes direct network access information such as electronic mail address, such further information can be provided by using the direct network access information as the destination. On the other hand, in case that only offline customer ID is available, said electronic information management module (406) directs subscriber management module (420) to search the customer database of said data storage module (407) for the registration information of the provided ID, retrieves the direct network access information from the registration information, transmits such further information to the network access information as the destination.

There are two possible paths through which electronic information is delivered to customer information terminal (10) by using electronic mall address or by using ID of portable information device (cellular phone number or miscellaneous ID): the direct connection path through network like the Internet (35) and the connection path routed and relayed by network access server (37) via communication networks (41, 43, 45, and 47).

Said electronic information management module (406) accumulates statistics on the customer access frequency and request frequency to specific electronic information such as advertisement based on information on received entries and device IDs of electronic information gateways (300), stores such statistics in data storage module (407), and transmits them to other servers via data link module (402). The data storage module (407) of said electronic information provision server (400) can optionally store types or classifications (according to different industrial fields or different event or service types, e.g. advertisement of food, sports marketing advertisement, or corporate image advertisement) of electronic information such as advertisement stored in each gateway in a database form, and the said electronic information management module (406) collects degree of responsiveness of each types of electronic information out of received data from each electronic information gateway and identifier of each gateway in order to make targeting decision on the contents of electronic information for each electronic information gateway automatically or manually by administrators via connection processing and management module (405).

In one embodiment of the present invention, said electronic information provision server (400), instead of providing cyber money and electronic discount coupon directly to customers, transmits identification information including customer identifier to information provider servers that is the source of the further electronic information that is identified by received electronic information identifier such as URL, so that such further information provider server executes value-added service such as providing and accumulating reward points to the customer. In such an embodiment, said information provider server can provide monetary reward, products and service that corresponds to the accumulated value of reward points or can provide various benefits corresponding to the accumulated value by connecting to the information provider server.

Such various rewards and benefits are also provided by the electronic information provision server (400) to the customer who expresses intention to acquire electronic information in addition to the provision from the directory information provider server. Such rewards and benefits can be accumulated upon customer's expression of information acquisition intention.

In one embodiment of the present invention, said electronic information gateway (300), instead of transmitting stored entries consisting of customer identifier and electronic information identifier to the electronic information provision server (400), acquires customer identification information from cards and tags, extracts network access address or ID of customer's portable information device from the acquired customer identification information, and directly transmits further electronic information stored in the gateway as links or contents form to said extracted network address as the destination in a form of electronic mails or of short messages in order to deliver further information to the network account the customer can access exclusively.

In order to achieve this, said electronic information gateway (300) receives more detailed version of electronic information from the electronic information provision server (400) when it receives the electronic information and stores them in memory storage unit (180), or alternatively receives detailed contents or link by requesting such detailed information to the information provider server connected to network.

In one embodiment of the present invention, wherein said electronic information gateway (300) provides further information directly in a form of electronic mails, the gateway either can connect to the electronic information provision server (400) in order to transmit electronic mails to the customer by using the electronic mail functionality of the data service module (404), or alternatively when equipped with direct electronic mail functionality as a reduced feature set of the ISP (Internet Service Provider) and with separate IP address can transmit electronic mail message that includes further information of the original electronic information to said extracted electronic mail address of customer as the destination via network (41, 43, 45, or 47). Such electronic mail messages are transmitted through global inter-network (35) such as the Internet to the customer's exclusive mail account. Likewise, further information delivery using the short messaging service can also either be achieved using messaging functions of the electronic information provision server (400) or messaging functions of the electronic information gateway which will directly deliver further information to information devices of customers.

In one embodiment of the present invention, digital signature generated by security keys (public or private) stored in the ID card of the customer is provided and transmitted together with the electronic information to the electronic mail account of customer, in order for the customer to confirm the received electronic mail is the one initiated by himself or herself when the customer expressed intention to acquire the electronic information.

In one embodiment of the present invention, wherein customer's ID card is a certain form of billing method such as credit card or is associated to a billing method, the payment method identifier is attached to the said electronic information, retrieves billing method at the electronic information provision server from the customer ID, or by storing billing method information in the customer's information devices, in order to use the corresponding payment method as the default billing method.

The description of the embodiments described previously has described proximity cards and tags. Surely, contact type cards and tags can be used for the same purpose.

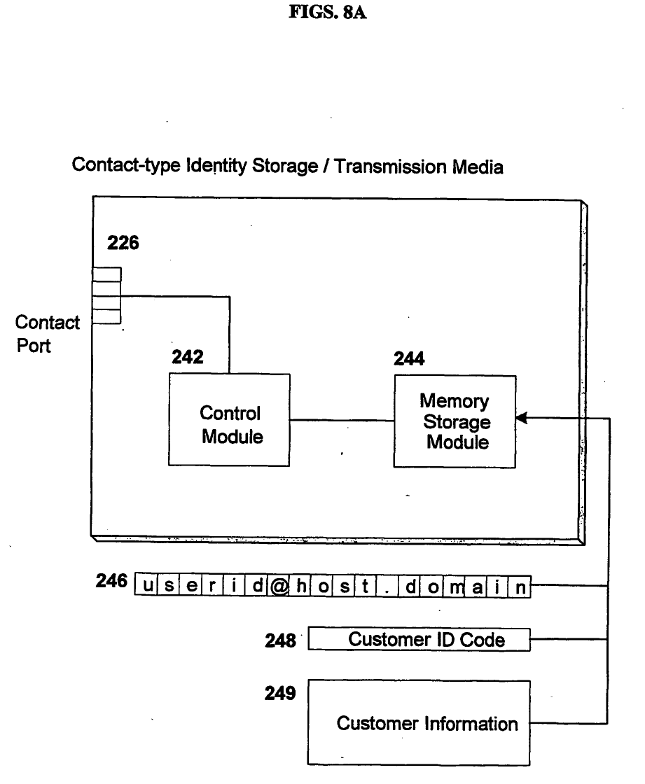

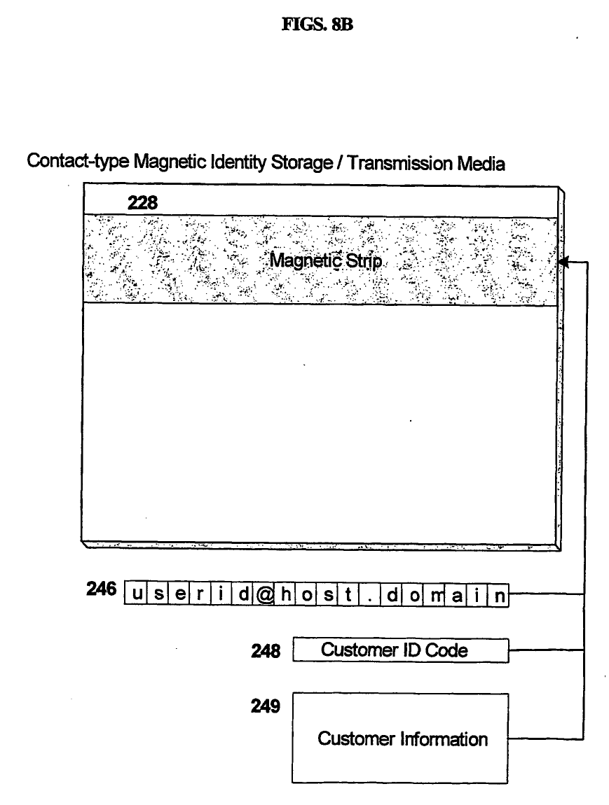

The contact type methods are either by electrical contact or by magnetic contact. Architecture of cards and tags is illustrated in FIG. 8a and FIG. 8b. Such cards and tags are manufactured as an independent unit for personal use and wear, can alternatively be manufactured in a way such that the cards and tags can be integrated into portable terminals such as cellular phones, PDA and portable computer. Surely, it is also possible to integrate circuit structure of the storage media as in FIG. 7 and FIG. 8a to the customer portable information device instead of attaching the physical cards and tags to portable device.

FIG. 8a illustrates the circuit architecture of electronic contact type cards which consists of contact interface (226) through which power, clock and data flow, memory module (244) that stores customer identification information (246, 248, 249), and control module (242) that retrieves data from said memory module (244) and transmits the data to outside via said contact interface (226) synchronously to the outside clock.

FIG. 8b illustrates the architecture of magnetic strip cards which have a magnetic strip typically in one side of the cards. The magnetic strip stores said customer identification information (246, 248, 249) magnetically.

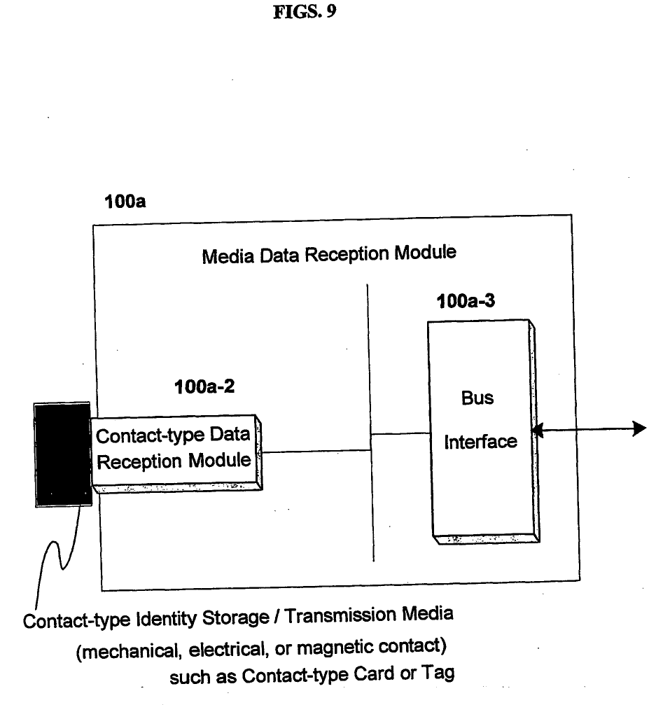

In FIG. 9 media data reception module (100a) makes a contact to the contact interface (226) of cards and tags shown in FIG. 8a, data reception module (100a-2) provides power and clock through the contacted interface by which control module (242) of cards and tags retrieves all data stored in the memory module (244) and transmits them as a bit sequence through the contact interface (226) synchronously with the provided clock signal. When the contact-type data reception module (100a-2) receives the transmitted bit sequence, it converts the bit sequence to a certain parallel data sequence and transmits the data to the control module (170) of the electronic information gateway (300) through the bus interface module (100a-3). The remaining process is the same as that of one embodiment for contactless cards and tags.

In one embodiment of the present invention, wherein cards and tags have a magnetic strip (228) on them, the said media reception module (100a) retrieves data magnetically through magnetic head, converts it to electrical signal, and transmits it to the control module (170) through bus interface module (100a-3).

In another embodiment of the present invention, the said media data reception module (100a) can be equipped both with the pins of the contact interface (226) and with the magnetic head, or alternatively two separate media data reception modules (100a), one for contact interface and the other for magnetic interface, can be provided, in order to interface with both of two card types-electrical and magnetic.

Additionally, a single card or tag can include both the contact-type and the contactless interface in it. The customer can contact the card to or approach the card in proximity to the electronic information gateway to provide the customer identification information according to the interface type.

The method of delivering further information using the customer ID instead of customer's direct network access information briefly described previously can be conveniently utilized in one embodiment of the present invention where the identification process uses bio informatics or bodily information to identify customer's identity instead of using portable storage media such as cards and tags.

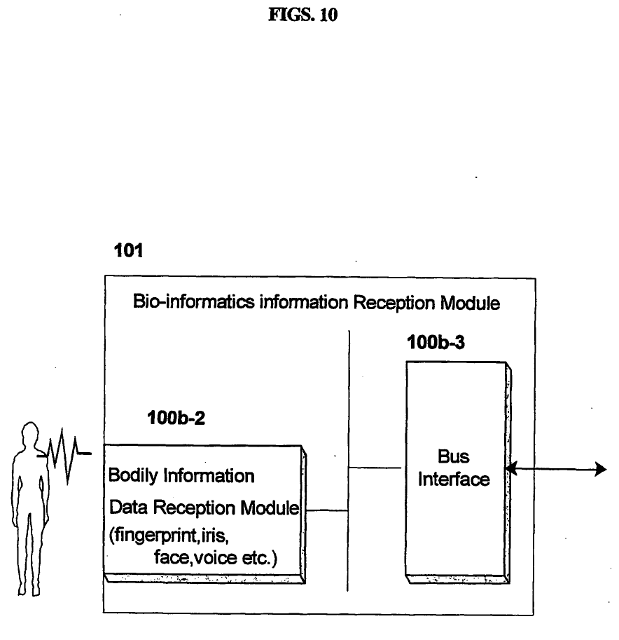

FIG. 10 illustrates the architecture of bio informatics reception module (101) of one embodiment of the present invention, which corresponds to the media data reception module (100) in previous embodiments of the electronic information gateway (300). The bio informatics reception module (100) consists of image data reception module (100-2) consisting of camera that accepts bodily image data and digitizes and compresses it and interface module (100b-3) that delivers the compressed digital image data to the control module (170) of the electronic information gateway (300).

The bio informatics reception module (101) FIG. 10 acquires bodily identification information and digital signature such as finger print, iris, face image, or voice, digitizes and compresses them, and transmits them to the electronic information provision server (400) together with the identifier of electronic information that is being presented at the point of customer contact (or together with the object identifier when no electronic presentation means is provided) according to the processes presented in embodiments of the present invention previously described. The electronic information provision server (400) identifies the customer who requested further information of specific electronic information by comparing with pre-stored customer bio informatics database. If identified as a qualified customer, the electronic information provision server transmits further electronic information by using customer's network access information as the destination.

The said method of delivering electronic information to customer's network access address acquired from portable storage media or from bodily information does not require high-level security provision mechanisms. This is because the further electronic information delivery method utilizing said customer identification method has a purpose of delivering acquisition intention of the further electronic information without being used for payment or access control. Hence, a high level of security mechanism is not mandated and so is not the cryptographic mechanism. The customer authentication will be carried out in later occasion if necessary, e.g. upon payment or transaction commit, during the ordering process using the delivered order form at a customer information access terminal.

In the case of using bio informatics information to identify customers, it is not required to transmit the acquired bodily data immediately as in electronic payment system and in access control system. Because the customer will access the further electronic information at a time later than the point of acquisition intention expression, it is sufficient to transmit the acquired bodily data with a certain latency during which said electronic information gateway (300) transmits the bio informatics and bodily data to said electronic information provision server (400) which in turn extract customer's characteristics from the data to identify the customer and retrieve the corresponding network access information. Because a certain level of delay is permitted, very high level of processing power or networking bandwidth are not mandatory. Certainly, it is desirable to deliver information with latency as low as possible, especially when the network system is charged by the amount of traffic as in IS-95C wireless data network.

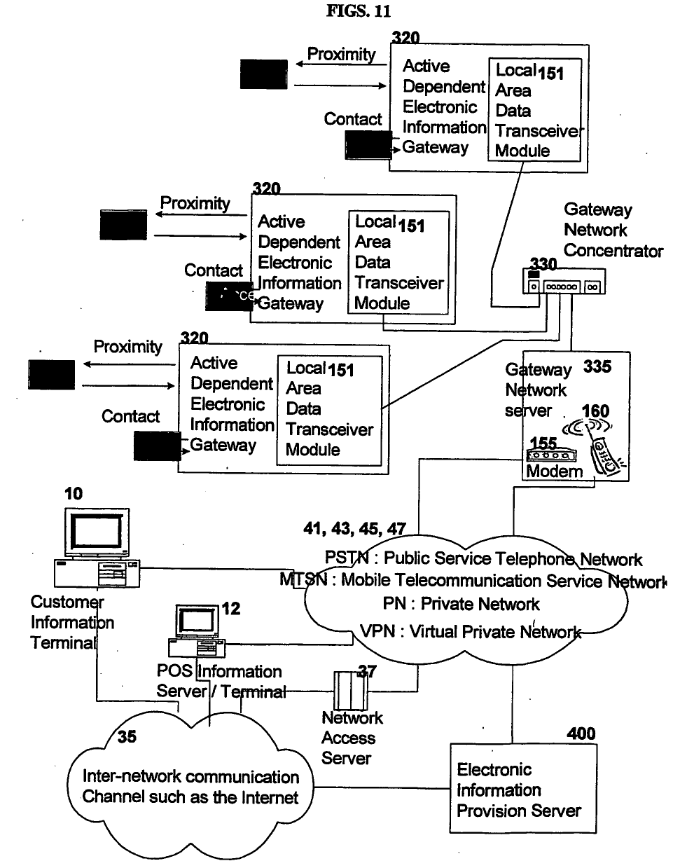

The description of embodiments of the current invention is based on the use of active-independent electronic information gateway (300) that has customer identifier acquisition means and network communication means to the provision server (400). Alternatively, in other embodiments of the present invention, the active-dependent type electronic information gateway (320) can be used to realize the method of obtaining personal access information and delivering further electronic information to the obtained access information as the destination. FIG. 11 illustrates the system and network architecture as an embodiment using the active-dependent gateway.

The active-dependent electronic information gateway (320) of the embodiment shown in FIG. 11 does not include wide area network access means to communicate to remote information provision server (400). Instead, it includes local area data transceiver module (151) which connects to local area communication network among gateways and to gateway network concentrator (330). The remote communication with the remote server (400) is achieved by separate gateway network servers (335).

In the embodiment presented in FIG. 11, one or more active-dependent electronic information gateways (320) connect to the gateway network server (335) via said local area data transceiver module (151) and via routing in the gateway network concentrator (330). Said gateway network server (335) relays communication between active-dependent electronic information gateways (320) in the local area gateway network and the electronic information provision server (400). Said gateway network server (335) can be realized as the modem pool consisting of high speed modems (155) and as the wired or wireless communication terminals (160; LAN, WAN, DSL, wireless modem or modem pool, WLL) which can connect to the electronic information provision server (400) via different communication networks according to different signaling mechanisms (PSTN for the phone-line modem pool, MTSN for wireless terminals, LAN or WAN for Network interface cards, Digital subscriber line for DSL modem).

It is desirable in the embodiment shown in FIG. 11 to place plurality of active-dependent electronic information gateways in geographically adjacent locations and to use shared gateway network server (335) in order to lower system equipment, operation, and management cost.

Instead of using active electronic information gateway in the previous embodiments of the present invention which are illustrated in FIG. 4 and FIG. 11, the passive electronic information gateway apparatus (340) can be utilized in another embodiment of the present invention.

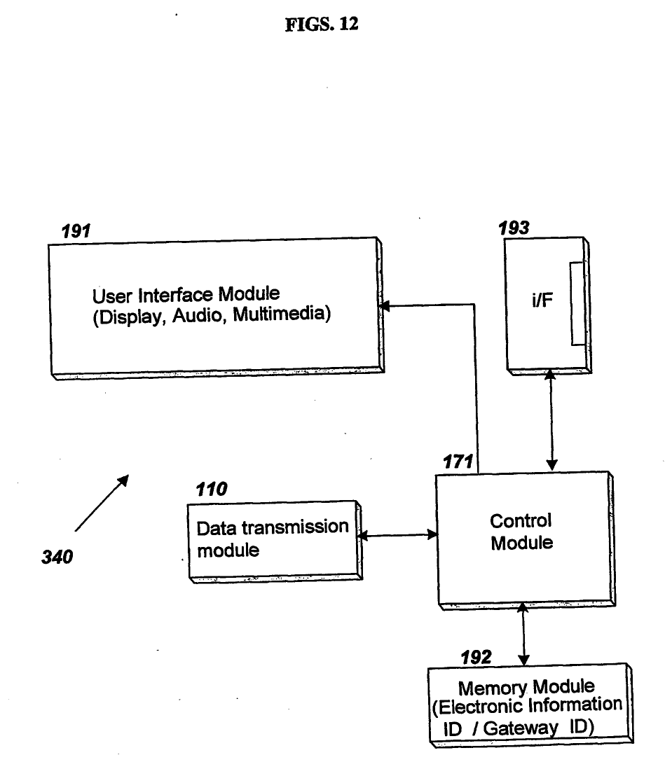

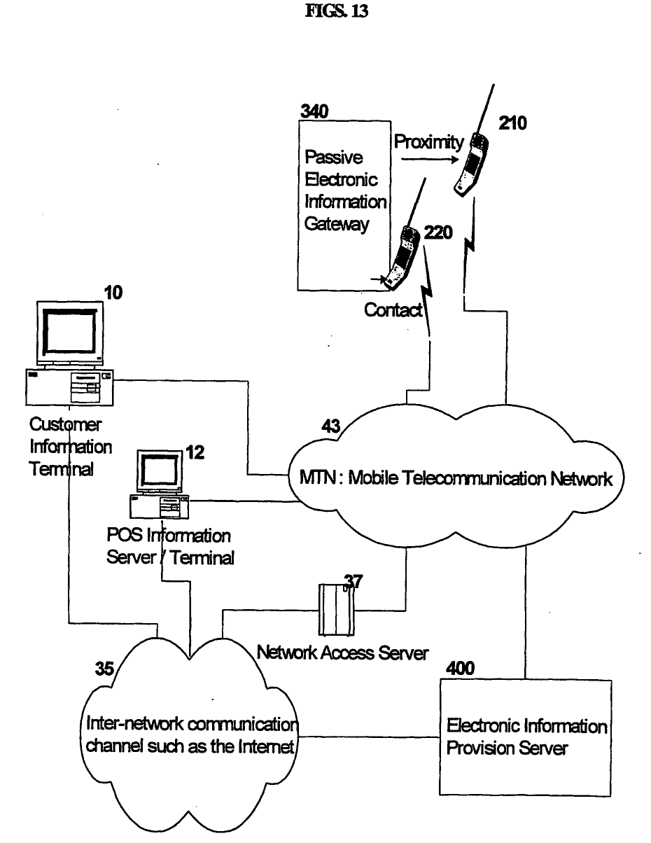

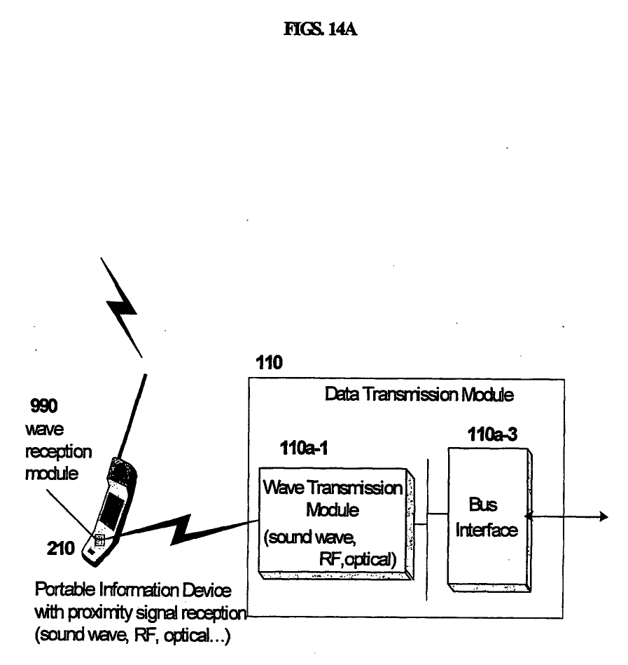

FIG. 12 illustrates architecture of such passive electronic information gateway (340), and FIG. 13 illustrates the system and network architecture for the method of obtaining personal access information and delivering further electronic information to the obtained access information as the destination of the present invention realized by using the said passive electronic information gateways (340).

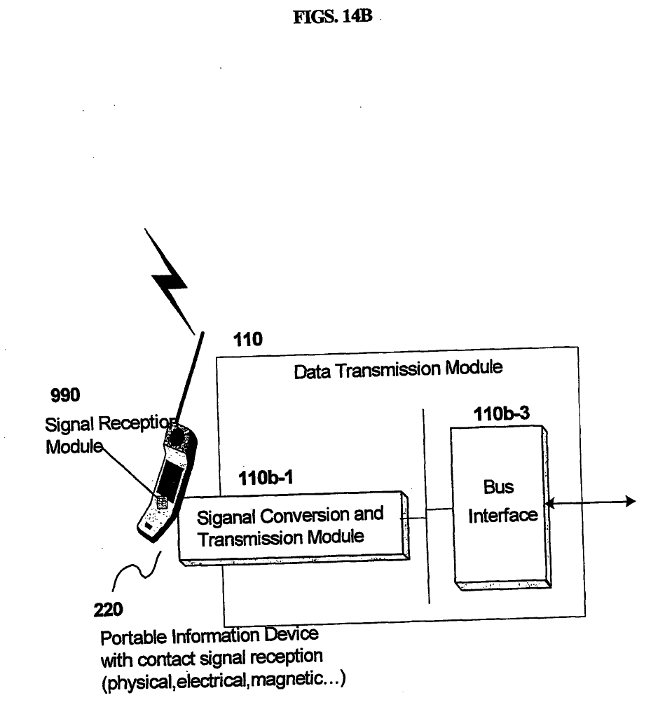

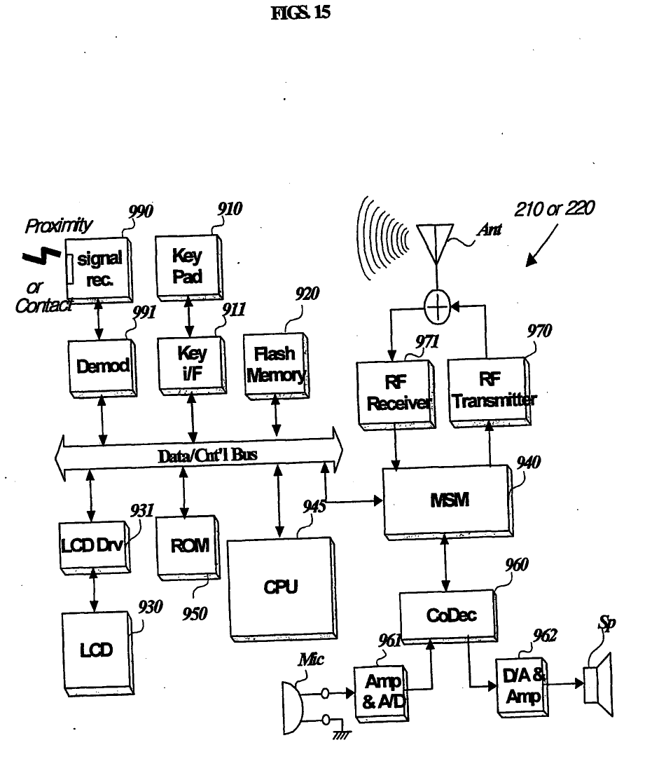

As shown in FIG. 12, the said passive electronic information gateway (340) consists of the user interface module (191) that presents electronic information such as advertisements, memory module (192) that stores electronic information that is presented by the said user interface module (191), its identifiers, and device IDs, connection port module (193) that connects to external devices physically to receive data, data transmission module (110) that transmits designated data in said memory module (192) in RE or infrared form when a portable information device is approached or contacted, and control module (171) that controls operation of each module and data flow among modules. Said data transmission module (110) can be realized as shown in FIG. 14a and FIG. 14b for proximity (contactless) and contact type devices, respectively.

For proximity type devices, the said data transmission module (110) consists of wave transmission module (110a-1) that transmits audio, optical, or RE signal modulating data signal and bus interface module (110a-3) that forwards data on the internal bus of the gateway to the said wave transmission module (110a-1). For contact type devices, the said data transmission module (110) consists of signal conversion and transmission module (110b-1) that transmits inbound data by converting it to the sequence of data corresponding to its interface pins, and bus interface module (110b-3) that forwards data on the internal bus of the gateway to the said signal conversion and transmission module (110b-1).

When said passive electronic information gateway (340) senses a computer device such as a notebook or PDA computer being connected to the said connection port module (193) during the offline operation, it retrieves plurality of electronic information and its identifier, stores them in the said memory module (192), and presents electronic information in sequence periodically via the said user interface module (190) for customer's recognition through auditory and visual senses, when the electronic information includes one or more presentation information. If the customer expresses intention to acquire further electronic information of the current presentation information by approaching or contacting portable information device (210, 220) to the said data transmission module (110), the data transmission module (110) verifies the compatibility and interoperability of the portable information device by exchanging auditory, optical, infrared, and RE signals via the said wave transmission module (110-a1) or by exchanging electrical or magnetic signals via ports of the said signal conversion and transmission module (110b-1). Once verified, said control module (171) transmits identification information of the current presentation information (by the user interface module (191) or implicitly by associated physical objects), such as URL or pre-assigned unique identifier to said portable information devices (210, 220).

Such passive electronic information gateway (340) has only the short range signal transmission means such as RE transceiver without the need of network access means. Hence it is less costly to implement the passive gateways than the active gateways (330, 320).

Said portable information device (210, 220) of customers should have signal reception means that receives wireless or wired signal transmitted by said passive electronic information gateway (340) in order to communicate with the passive electronic information gateway. It is desirable to use portable information device of embodiments of the present invention equipped with infrared reception module or wireless bluetooth module. The architecture of one embodiment of such portable information device is illustrated in FIG. 15.

The portable information device shown in FIG. 15 consists of keypad (910) for data input, keypad interface module (911) that receives key input data by connecting to said keypad, flash memory module (920) that stores customer or device identification information that is input by said keypad (910), stored previously, or delivered via network, Liquid Crystal Display (LCD) (930) that outputs information required for operation, LCD display driver module (931) that converts data to LCD signal, Read-Only Memory (950) that stores programs, CODEC (Coder-Decoder) (960) that converts inbound compressed digital audio data to analog audio signal and converts inbound analog audio signal to compressed digital audio data, A/D converter (961) that amplifies analog audio signal from microphone to a certain input level and converts is to digital data, D/A converter (962) that converts digital data to analog audio signal and outputs it to speakers after amplification, wireless transmitter (970) and wireless receiver (971) that transmits and receives RF signal wirelessly to and from the wireless network (43), respectively, station module (940) that performs connection processing and management and performs data modulation and demodulation according to wireless communication protocols, signal reception module (990) that exchanges signal with electronic information gateway (300) in contacts or in close proximity, signal demodulation module (991) that demodulates signal received from said signal reception module (990) and extracts data through demodulation, and central processing unit (945) that performs packet data processing program and operational program for various applications stored in said Random Access Memory (950). Said signal reception module (990) should be designed in a way that various forms of signal exchange, such as electrical, infrared, RF (such as bluetooth), magnetic signals can be received and processed.

Said portable information device (210, 220) receives signals from the said signal reception module (990) the passive electronic information gateway in proximity or in contact transmits, converts it to electrical signal, and transmits it to signal demodulation module (991) by low pass filtering it to base-band signal. Said signal demodulation module (991), then, demodulates the signal according to the signal demodulation method predefined with said electronic information gateway in order to transmit extracted electronic information identifier to said central processing unit (945) via internal bus module. The central processing unit (945) stores extracted electronic information identifier in flash memory module (920). Electronic information identification information acquired thereafter from various passive electronic information gateways will be accumulated to said flash memory module (920) likewise.

Said portable information device, while storing one or more electronic information identifier in said flash memory module (920), connects to a portal server that provides network service by letting the station module (940) perform connection processing via the wireless network (43) when customer make a connection request or dial using said keypad (910). Said central processing unit (945), then, launches the program that processes packetized data stored in said Random Access Memory (950).

The customer, then, selects by using said keypad (910) the data transmission service provided by the portal server, so as to transmit wirelessly via said wireless transmission module (970) electronic information identifier, customer identification information, or electronic mail address to said electronic information provision server (400) via said portal server. When the direct network communication means is establish between the portable information device and the said electronic information provision server (400), the customer portable information device directly transmits data stored in said flash memory module (950) wirelessly to said electronic information provision server (400), to the customer account, or to the portable information device, by constructing the data in electronic mails or in short messages and by converting the data to a wireless format in said station module (940) without making connection to intermediate server such as the wireless portal server.

The method of delivering further electronic information to the customer from the electronic information identifier and customer network access information using the said passive electronic information gateways are the same as that using active electronic information gateways.

In one embodiment of the present invention, said passive electronic information gateway (340) transmits brief summary information of the current presentation information, such as product price or retailer locations, to the customer's portable information device in contact or in proximity in addition to the said electronic information identification information. The central processing unit (945) of the portable information device (210, 220) can display the summary information on the LCD (930) by communicating to LCD driver (931). The summary information is stored in the memory module (192) in relation to the contents or identifier of the electronic information in a separately addressable manner by using connection port (193) or by receiving from the electronic information provision server through remote data transceiver module (150) when remote data transceiver module (150) is provided. Hence, customer can acquire brief summary information in addition immediately at the point of contact using the portable information device, while at the same time further detailed information is transmitted to the network access address of the customer for future decoupled browsing, according to said methods and steps of customer access information and electronic information identifier transmission. Such brief summary information can include link to further information so as to enable immediate access by using network connection means of the portable information device. Generally, customers can access further information by accessing customers network access point represented by the said network access information at a stationary or a portable information terminal device.

In order to receive, store, and display brief summary information, the customer portable information device should have the application program, in addition to the general operational system program of the device, that performs classification and storage of those data obtained by said signal reception module (990) and signal demodulation module (991) according to their attributes (such as customer network access information or further detailed information of electronic information) and that performs display operation on LCD (930), in the Random Access Memory (950) of the portable information device shown in FIG. 15. The stored program is run on the central processing unit (945) of the portable information device.

Such method and process of delivering brief summary information together with the electronic information identifier to let the customer access the summary immediately using the portable device can be implemented likewise when the said passive electronic information gateway has optional remote data transceiver module (150) that make a connection through the network with the electronic information provision server (400) in addition to the configuration shown in FIG. 12.

In the embodiment of the present invention, wherein the electronic information identifier is a URL, said electronic information provision server (400), instead of identifying further electronic information with the URL and retrieving and providing pre-configured or dynamically obtained further information, can redirect the customer's information terminal to the information server that serves the URL in order for the customer to retrieve information directly from the information server that serves the URL.

In addition, the passive electronic information gateway (340) transmits its device ID together with the electronic information identifier to the portable information device (210, 220) and make this device ID information delivered to the electronic information provision server (400) using the process similar to the above, in order to use collected such information in generating analysis result of delivery or effects of electronic information in particular advertisements.

The passive electronic information gateway (340) shown in FIG. 12 can also directly transmit more detailed version of the electronic information directly to the portable information device instead of transmitting the electronic information identifier alone when customer expresses intention to acquire electronic information. When said passive electronic information gateway (340) is equipped with a remote data transceiver (150), the gateway receives further detailed information together with the electronic information (when presentation means is provided) for presentation, stores them in memory module (192), and provides them upon customer's further information request. Otherwise, said passive electronic information gateway can obtain further information from the information devices such as notebook computer having large magnetic or optical disk storage by copying further information together with the electronic information via the connection port (193). Alternatively, said passive electronic information gateway can have at least a part of its memory storage module (192) with the replaceable optical disk storage, such as CD, DVD, magneto-optical disk, wherein electronic information for presentation and further detailed information can be provided by replacing such disks.

The passive gateway retrieves presentation information from the optical disk, presents it by using the user interface module (191), and provides further detailed version of the electronic information through the data transceiver module (110).

With the electronic information gateways having replaceable storage media such as optical disks, it is possible to provide new and modified information for presentation (when presentation means is provided) or further detailed information by replacing such media inside the storage media drive in order to change contents of information and advertisement. Hence, such passive electronic information gateway does not have to operate online to retrieve update information from the electronic information provision server.

When customer expresses intention to acquire further detailed information from such passive electronic information gateway, the customer can retrieve information which is complimentary to the electronic information. Examples of such complimentary information is product price listing or retailer location or electronic order form when the electronic information is a product advertisement, public relation or investor relation information of a corporation when the electronic information is a corporate image advertisement, hour of operation or transportation means when the electronic information is a travel advertisement. Acquired information can be accessed immediately by using the same portable information device or by using different information terminal later at a different place.

In the case of direct provisioning of further detailed electronic information from electronic information gateways, the gateway can also provide the identification information of the electronic information which was previously received and stored or alternatively stored in disk storage media. It is desirable in such case to have URL of the product order form or site.

If URL is used as the identifier of electronic information, the customer transmits electronic order forms inside the acquired further information after filling the order form using any information terminal to the said electronic information provision server (400) which then records the gateway id from which the order form was originally initiated and transmits the order from the customer to the specific electronic commerce server that serves the received URL by extracting the electronic commerce server address from the URL. Certainly, the customer can directly connect to the electronic commerce server whose link is included in the delivered further detailed version of electronic information.

Regardless the electronic information gateway be active (300, 320) or passive (340), if portable storage media or portable information device stores the network access information of the customer's portable telecommunication terminal or electronic mail account address on the server which is conveniently accessed by the portable telecommunication terminal as the customer's network access information, the customer is able to access further detailed version of the electronic information by using the portable telecommunication terminal when the customer expresses intention to acquire such information by placing cards, tags, and portable information device (including the said portable telecommunication terminal) in close proximity to or in contact to the electronic information gateway (300, 320, 340).

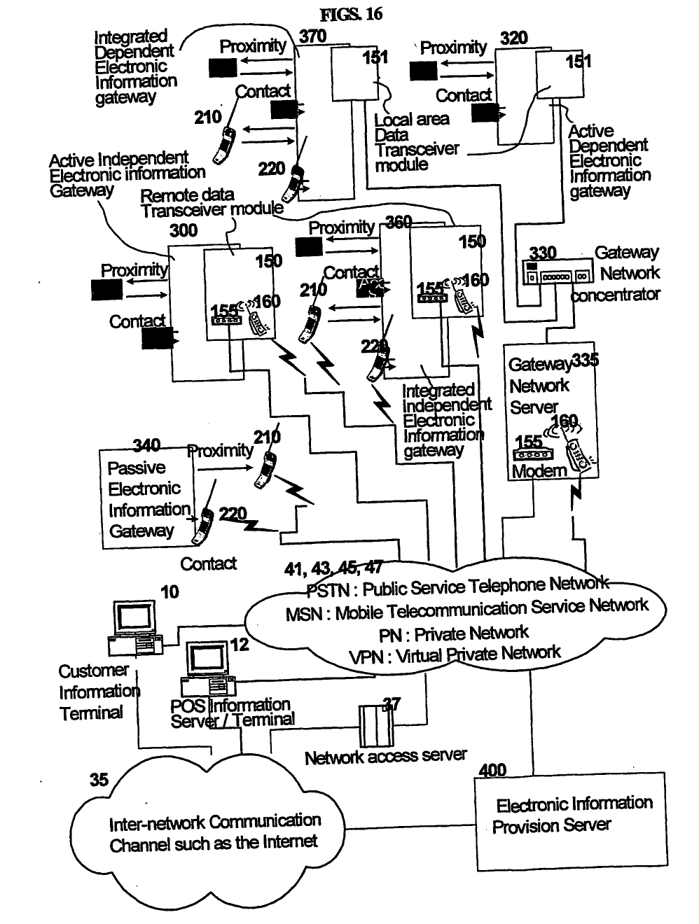

FIG. 16 illustrates one embodiment of the system and network architecture which is comprised of various types of electronic information gateway apparatus and which provides methods for obtaining personal access information and delivering information in electronic form using the obtained personal access information of the present invention, with different connection mechanisms for different types of gateways. The integrated electronic information gateway of FIG. 16 (360, 370) consists of both the active and the passive electronic information gateways in it and can operate seamlessly with both the portable storage media (such as RFID tags (smartcards and tags)) and portable information device (such as cellular phones, notebooks, and PDAs).

In the system and network shown in FIG. 16, customers can exchange signals with the electronic information gateway that is interoperable to the portable storage media they want to use in order to transmit their network identity in which they access the delivered more detailed version of information.

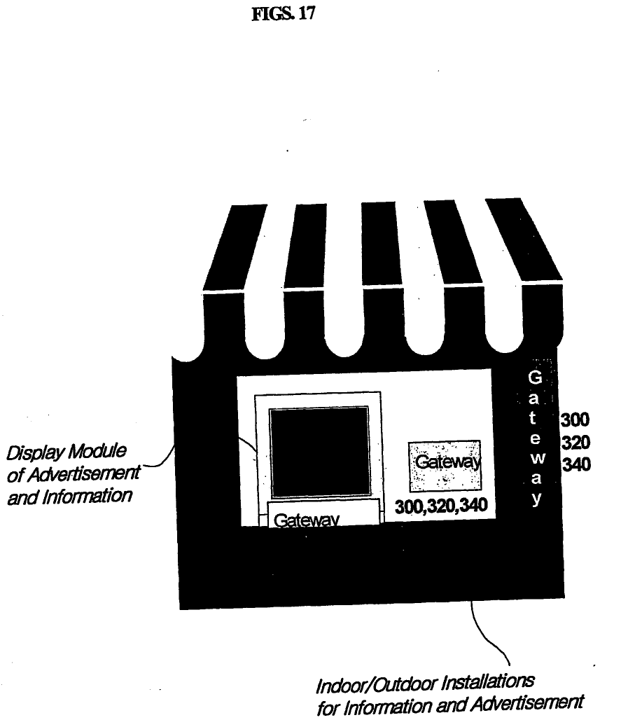

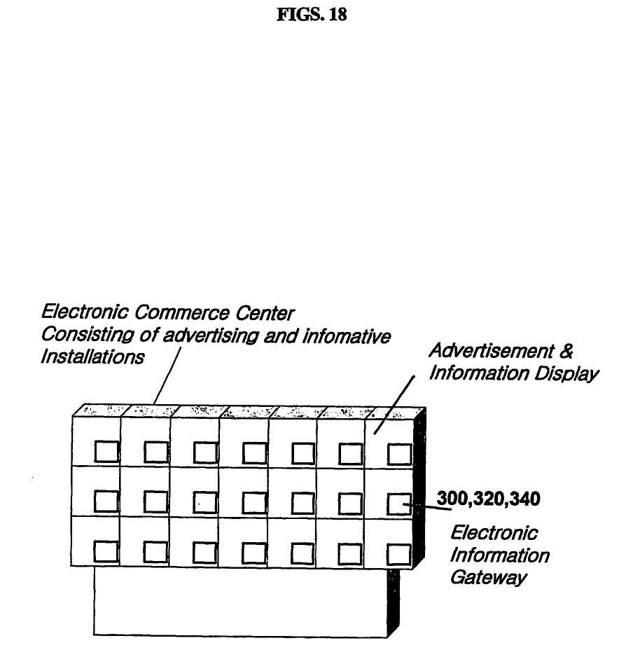

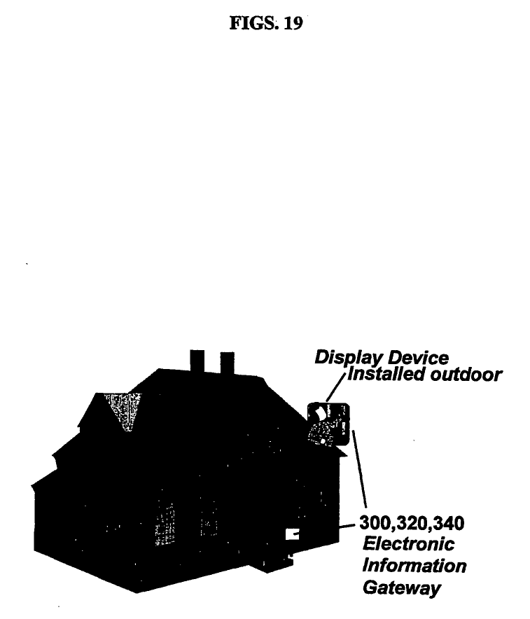

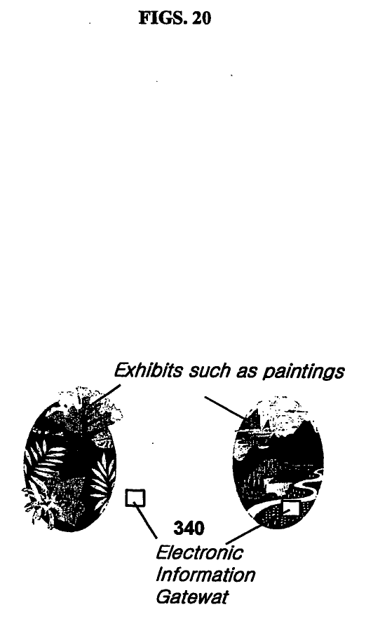

FIG. 17, FIG. 18, FIG. 19, and FIG. 20 illustrate possible installations and ambient environments of various electronic information gateways provided in plurality of embodiments of the present invention. FIG. 17 illustrates the electronic information gateway attached to advertisement signs, FIG. 18 illustrates plurality of electronic information gateways installed in a concentrated manner along with plurality of contents and informational contents from which customers selectively decides which information to acquire, FIG. 19 illustrates an installation where user interface module (190, 191) is placed in a well visible location while the said media data reception module (100) is placed in a well reachable point in space, and FIG. 20 illustrates the electronic information gateway installed close to exhibits such as paintings. In addition to these, the electronic information gateway can be installed or attached to physical objects in general with or without material, wherein said electronic information gateway should have unique object identifier that identifies such object uniquely in physical space or in networked cyber space. The gateway device can exist as a standalone device which then represents object without material or abstract conceptual subject.

When it is required to install the electronic information gateway with a small footprint, it is possible to construct gateway devices without presenting the electronic information on the user interface module. In this case the interface module (190, 191) shown in FIG. 5 and FIG. 12 will be eliminated in the installation.

Additionally, it is desirable to implement the remote data transceiver module (150) shown in FIG. 5 by using wireless transceiver module, in particular when electronic information in small size in many points in small space, although it is still possible to use wired connection. Due to the size constraint, it is not feasible to implement high power wireless transmission. Hence, it is desirable to concentrate low power wireless signals of local area and interconnects such local area wireless networks using wired network.

In the installation shown in FIG. 20 wherein electronic information gateways are small in size, the identification information that represents presentation information of objects, advertisement, or informational contents can be set online by selecting gateways from outside server as in FIG. 5, or can be set by the portable key input method-e.g. portable computer-connected to the said connection port (193) or by the embedded keypad input. The external content identification method representing the contents of signs, installations, and exhibits is stored as a single information entry in the memory module (180, 192).

In such installation settings, customer browses signs, installations, exhibits, products, and other types of objects, expresses intention to get more detailed information or order forms by approaching smartcards, tags, part of body in contact or in proximity to the said gateway device, the gateway then extracts customer's network access information from the inbound signal, transmits the identification information of the external object which is stored in said memory module (180, 192) together with the extracted customer network access information directly to the corresponding customer or to the electronic information provision server (400) (active), or redirects customer's portable information device to get information directly from the information provision server (400) (passive).

The following description explains an electronic commerce process according to one embodiment of the method for obtaining personal access information and delivering information in electronic form using the obtained personal access information of the present invention.

The customer connects to the electronic information provision server (400), provides his or her payment information such as credit cards, account number, and/or digital signature together with his or her ID to register and use electronic commerce service.

For customers registered as such, when the said electronic information provision server (400) receives requests for the more detailed information, the server records the requested information, requested time and ID of the gateway apparatus. The server then transmits electronic order form as a more detailed information to the customer. The customer, then selectively fills information fields such as the product to purchase, original order form request time, the gateway ID, customer's identity such as electronic mail ID, portable information device ID (such as cellular phone number) and transmits the filled form back to the electronic information provision server (400). The server then can identify the customer again from the provided information field values. For instance the server can try to match the request time received from the gateway and from the customer, and authenticate the user's intention expression when the difference in time is within a certain range, e.g. 30 minutes. Once authenticated, the information provision server requests possibly different electronic commerce server to initiate electronic commerce transaction with the customer. At the same time, the information provision server encrypts payment information of the customer using security key of the customer or the server which can be decrypted either by the security key stored in the customer's computer or in the customer's smartcard in order to process procurement and payment as fast and as secure as possible in the networked cyber space.

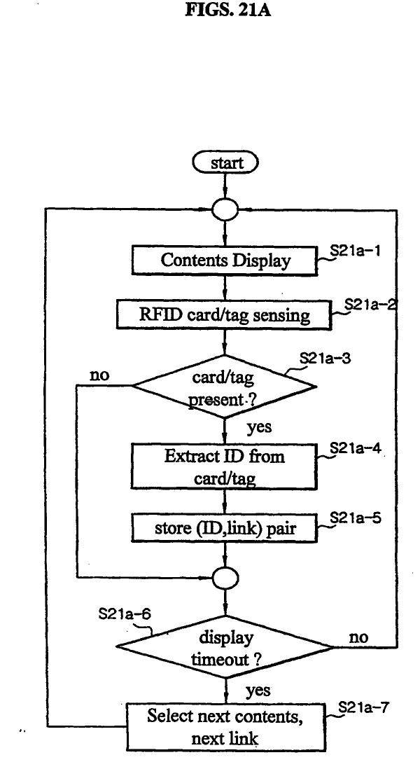

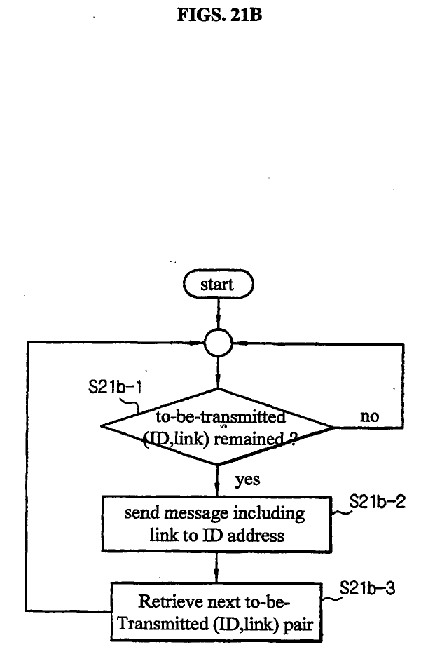

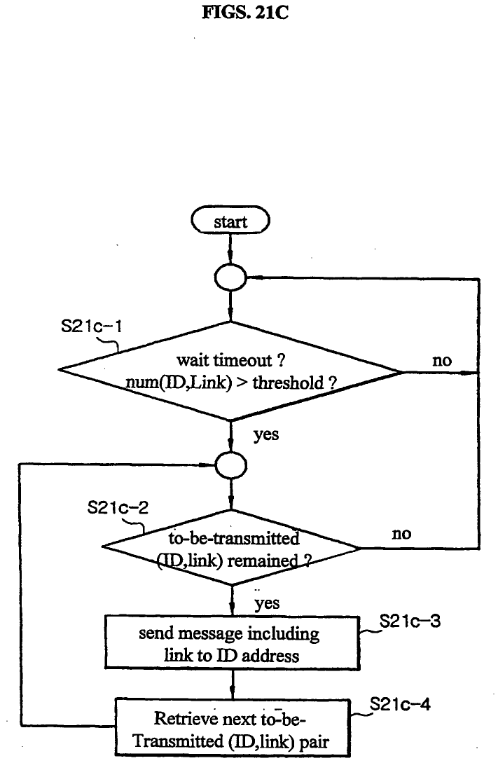

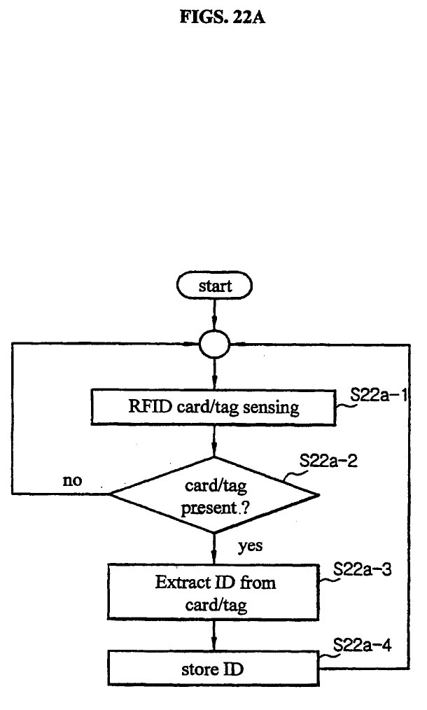

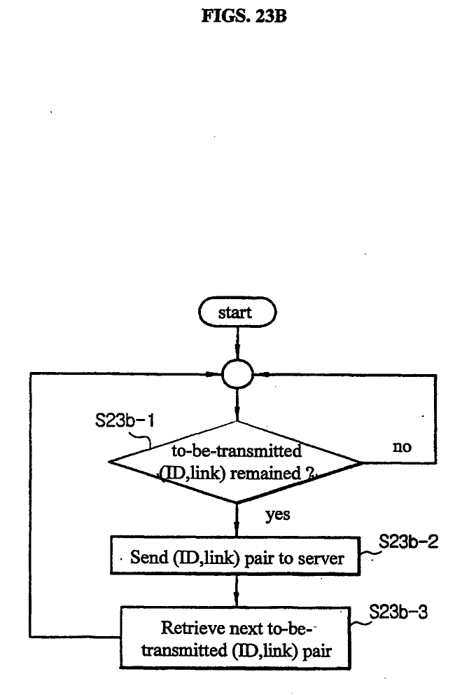

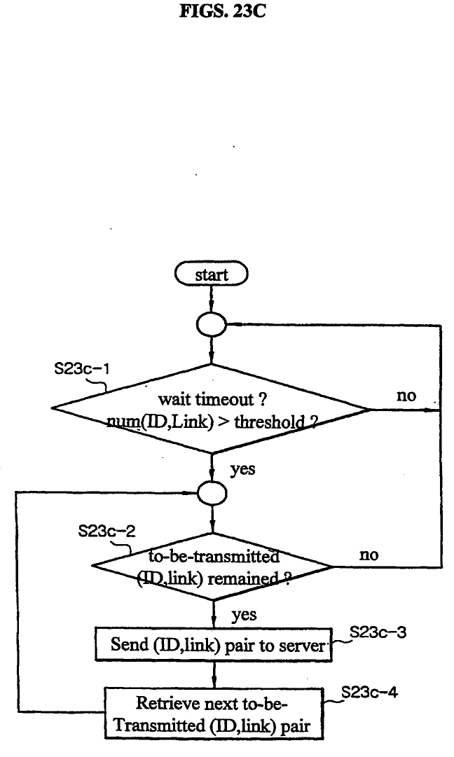

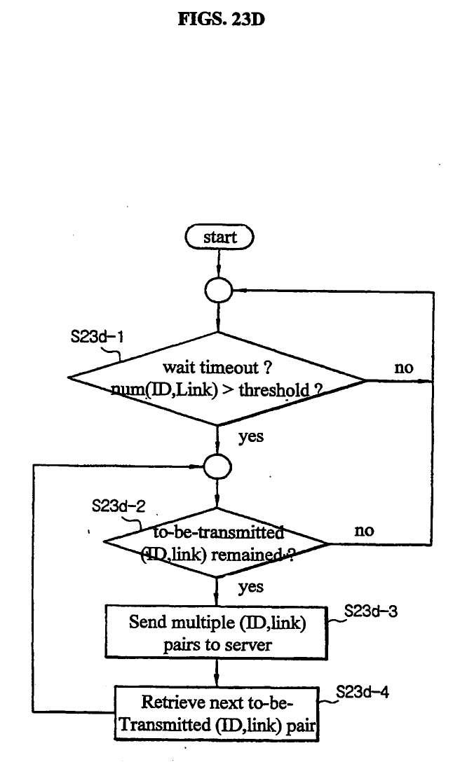

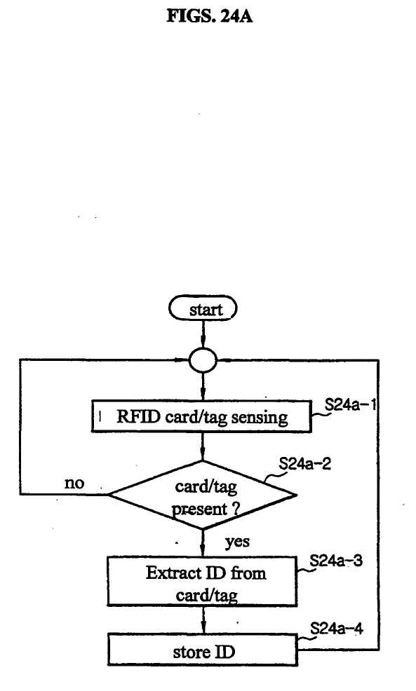

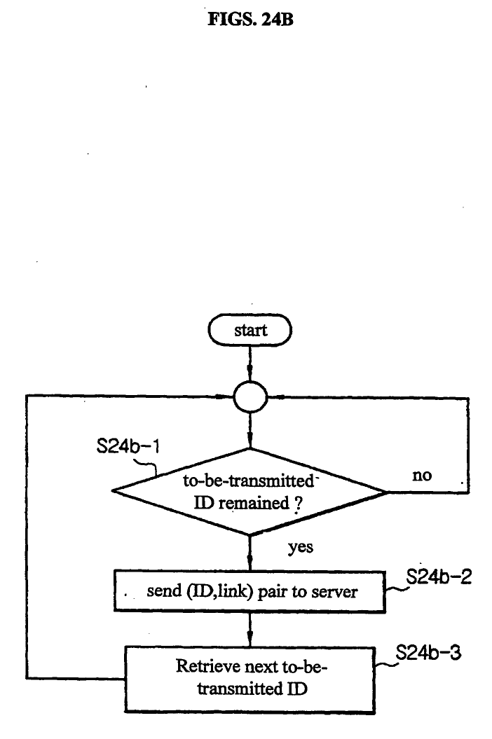

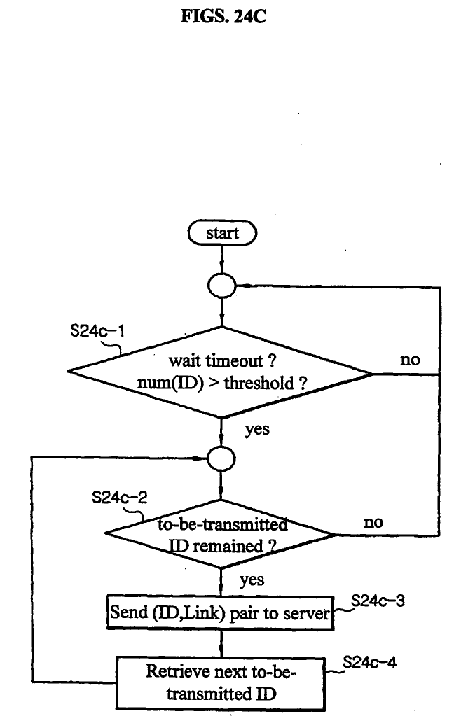

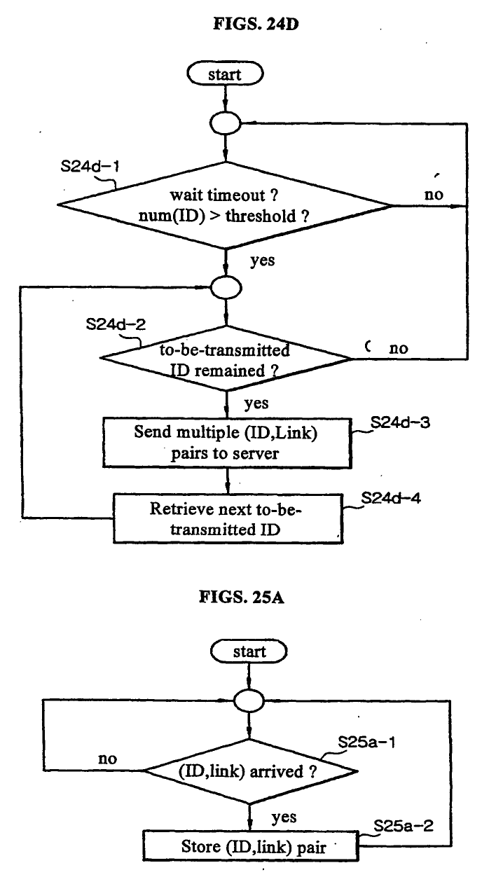

FIG. 21a, FIG. 21b, FIG. 21c, FIG. 23a, FIG. 23b, FIG. 23c, and FIG. 23d illustrate electronic information delivery method according to one embodiment of the present invention, wherein the electronic information gateway apparatus is equipped with the presentation means.

FIG. 21a, FIG. 21b, and FIG. 21c illustrate an embodiment wherein electronic information gateway equipped with the presentation means directly transmits messages to customers. FIG. 21a is a flow of card and tag sensing and storage task, FIG. 21b is a flow of message collection and immediate transmission task, and FIG. 21c is a flow of periodic message transmission task.

According to the embodiments illustrated in FIG. 21a, FIG. 21b, and FIG. 21c, the electronic information gateway stores one or more electronic information and their identifiers, presents (s21a-1) such stored electronic information periodically after reading from the storage media, senses (s21a-2, s21a-3) signal reception from the portable storage media, acquires (s21a4) from the received signal the identification information that uniquely identifies customer in network, extracts link information that identifies electronic information that is being presented at the point of such contact, couples and stores (s21a-5) said identification information and link information, and performs (s21a-6, s21a-7) checking of level of latency and selection of contents and links. As illustrated in FIG. 21b, the electronic information gateway decides (s21b-1) whether there remain to-be-transmitted messages by checking said constructed message, transmits (s21b-2) the message containing the said link information directly to the said identification address immediately upon message collection or performs (s21b-3) the next to-be-transmitted message selection process. As illustrated in FIG. 21c, the electronic information gateway checks (s21c-1, s21c-2) whether the number of timed-out messages or to-be-transmitted messages exceeds predefined threshold, transmits (s21c-3) the message containing the said link information directly to the said identification address immediately upon message collection or performs (s2 lc4) the next to-be-transmitted message selection process.

FIG. 23a, FIG. 23b, FIG. 23c, and FIG. 23d illustrate an embodiment wherein electronic information gateway equipped with the presentation means transmits messages to electronic information provision server. FIG. 23a is a flow of card and tag sensing and storage task, FIG. 23b is a flow of message collection and immediate transmission task, FIG. 23c is a flow of periodic message transmission task, and FIG. 23d is a flow of periodic and simultaneous transmission of plurality of messages.

According to the embodiments illustrated in FIG. 23a, FIG. 23b, FIG. 23c, and FIG. 23d, the electronic information gateway stores one or more electronic information and their identifiers, presents (s23a-1) such stored electronic information periodically after reading from the storage media, senses (s23a-2, s23a-3) signal reception from the portable storage media, acquires (s23a4) from the received signal the identification information that uniquely identifies customer in network, extracts link information that identifies electronic information that is being presented at the point of such contact, couples and stores (s23a-5) said identification information and link information, and performs (s23a-6, s23a-7) checking of level of latency and selection of contents and links. As illustrated in FIG. 23b, the electronic information gateway decides (s23b-1) whether there remain to-be-transmitted messages by checking said constructed message, transmits (s23b-2) the message containing a coupled pair of the said identification address and the said link information to the electronic information provision server or performs (s23b-3) the next to-be-transmitted message selection process. As illustrated in FIG. 23c, the electronic information gateway checks (s23c-1, s23c-2) whether the number of timed-out messages or to-be-transmitted messages exceeds predefined threshold, transmits (s23c-3) the message containing a coupled pair of the said identification address and the said link information to the electronic information provision server or performs (s23b4) the next to-be-transmitted message selection process. As illustrated in FIG. 23d, the electronic information gateway checks (s23d-1, s23d-2) whether the number of timed-out messages or to-be-transmitted messages exceeds predefined Threshold, transmits (s23d-3) the message containing plural coupled pairs of the said identification address and the said link information to the electronic information provision server or performs (s23d-4) the next to-be-transmitted message selection process.

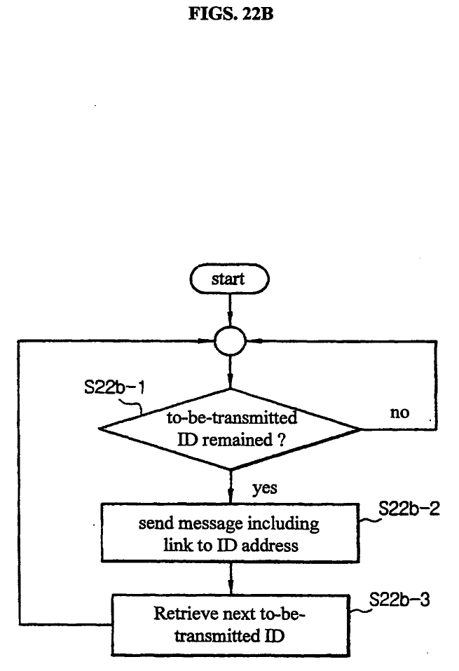

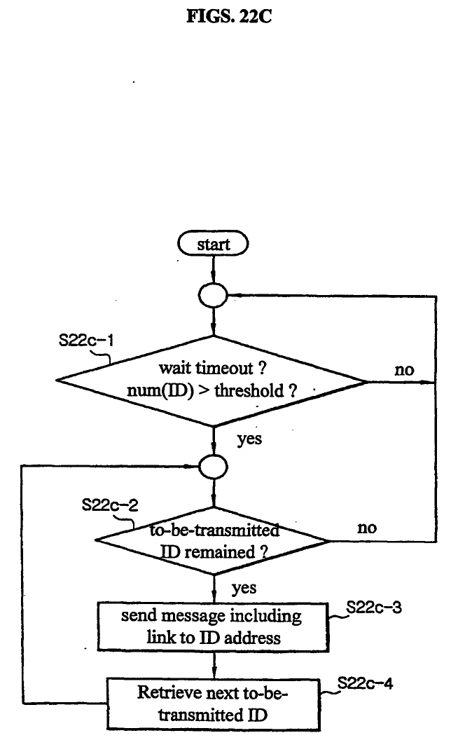

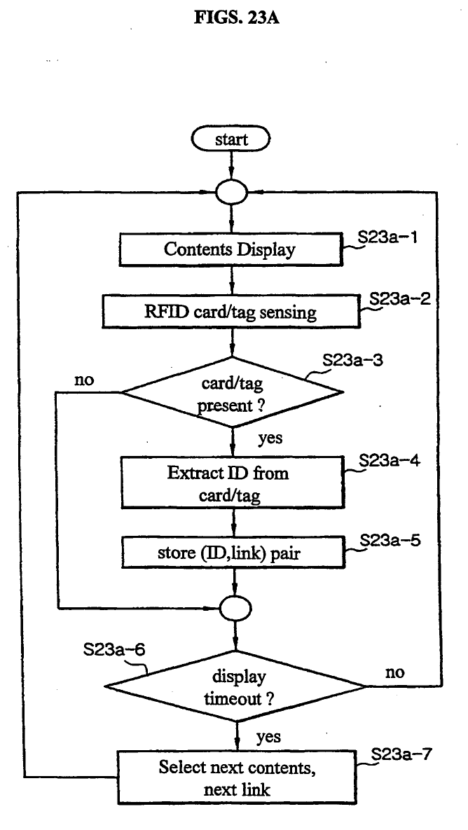

FIG. 22a, FIG. 22b, FIG. 22c, FIG. 24a, FIG. 24b, FIG. 24c, and FIG. 24d illustrate electronic information delivery method according to one embodiment of the present invention, wherein the electronic information gateway apparatus is not equipped with any electronic presentation means.

FIG. 22a, FIG. 22b, and FIG. 22c illustrate an embodiment wherein electronic information gateway equipped with the presentation means directly transmits messages to customers. FIG. 22a is a flow of card and tag sensing and storage task, FIG. 22b is a flow of message collection and immediate transmission task, and FIG. 22c is a flow of periodic message transmission task.

According to the embodiments illustrated in FIG. 22a, FIG. 22b, and FIG. 22c, the electronic information gateway stores the identification information (e.g. URL link) that uniquely represents or points to an object exposed in real physical places that is recognizable by the electronic information provision server on the network, senses (s22a-1, s22a-2) signal reception from the portable storage media, acquires (s22a-3) from the received signal the identification information that uniquely identifies customer in network, and stores (s22a-4) it. As illustrated in FIG. 22b, the electronic information gateway decides (s22b-1) whether there remain to-be-transmitted messages by checking said constructed message, transmits (s22b-2) the message containing the said link information directly to the said identification address immediately upon message collection or performs (s22b-3) the next to-be-transmitted message selection process. As illustrated in FIG. 22c, the electronic information gateway checks (s22c-1, s22c-2) whether the number of timed-out messages or to-be-transmitted messages exceeds predefined threshold, transmits (s22c-3) the message containing the said link information directly to the said identification address immediately upon message collection or performs (s22c-4) the next to-be-transmitted message selection process.

FIG. 24a, FIG. 24b, FIG. 24c, and FIG. 24d illustrate an embodiment wherein electronic information gateway not equipped with any presentation means transmits messages to electronic information provision server. FIG. 24a is a flow of card and tag sensing and storage task, FIG. 24b is a flow of message collection and immediate transmission task, FIG. 24c is a flow of periodic message transmission task, and FIG. 24d is a flow of periodic and simultaneous transmission of plurality of messages.

According to the embodiments illustrated in FIG. 24a, FIG. 24b, FIG. 24c, and FIG. 24d, the electronic information gateway stores the identification information (e.g. URL link) that uniquely represents or points to an object exposed in real physical places that is recognizable by the electronic information provision server on the network, senses (s24a-1, s24a-2) signal reception from the portable storage media, acquires (s24a-3) from the received signal the identification information that uniquely identifies customer in network, and stores (s24a-4) it. As illustrated in FIG. 24b, the electronic information gateway decides (s24b-1) whether there remain to-be-transmitted messages by checking said constructed message, transmits (s24b-2) the message containing a coupled pair of the said identification address and the said link information to the electronic information provision server or performs (s24b-3) the next to-be-transmitted message selection process. As illustrated in FIG. 24c, the electronic information gateway checks (s24c-1, s24c-2) whether the number of timed-out messages or to-be-transmitted messages exceeds predefined threshold, transmits (s24c-3) the message containing a coupled pair of the said identification address and the said link information to the electronic information provision server or performs (s24b-4) the next to-be-transmitted message selection process. As illustrated in FIG. 24d, the electronic information gateway checks (s24d-1, s24d-2) whether the number of timed-out messages or to-be-transmitted messages exceeds predefined threshold, transmits (s24d-3) the message containing plural coupled pairs of the said identification address and the said link information to the electronic information provision server or performs (s24d-4) the next to-be-transmitted message selection process.

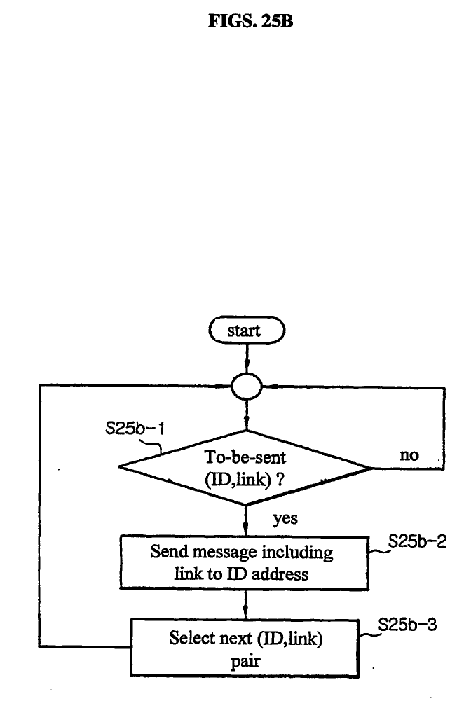

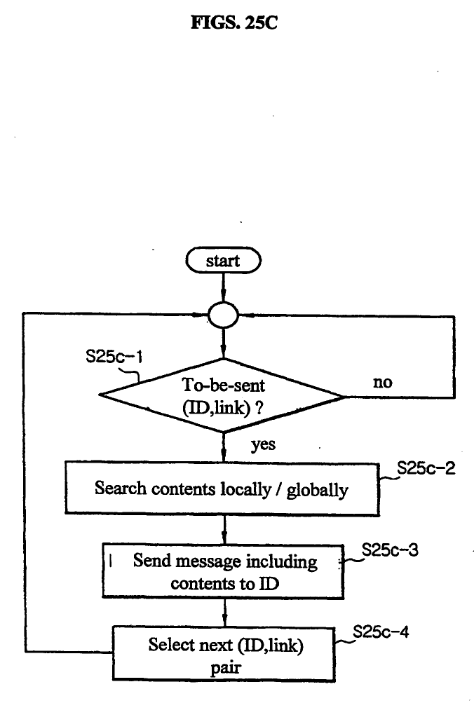

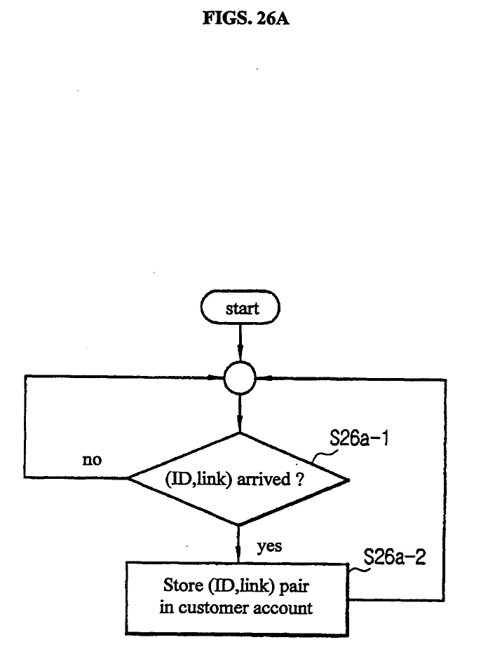

FIG. 25a, FIG. 25b, and FIG. 25c illustrate an embodiment of the present invention wherein electronic information provision server transmits message to customer. FIG. 25a is a flow of message reception task, FIG. 25b is a flow of link message transmission task initiated immediately upon link collection, and FIG. 25c is a flow of contents search and transmission tasks initiated immediately upon link collection.

According to the embodiments illustrated in FIG. 25a, FIG. 25b, FIG. 25c, and FIG. 25d, the electronic information provision server stores (s25a-1, s25a-2) pairs consisting of the customer identification information and link information which are received from the said electronic information gateway. As illustrated in FIG. 25b, the electronic information provision server transmits (s25b-1, s25b-2) the message containing a coupled pair of the said customer identification address and the said link information to the customer identification address as the destination immediately upon collection or performs (s25b-3) the next to-be-transmitted message selection process. As illustrated in FIG. 25c, the electronic information provision server searches (s25c-1, s25c-2) global or local networks for the contents represented by the said collected link information, transmits (s25c-3) the message containing a coupled pair of the said customer identification address and the said contents to the customer identification address as the destination or performs (s25c4) the next to-be-transmitted message selection process.

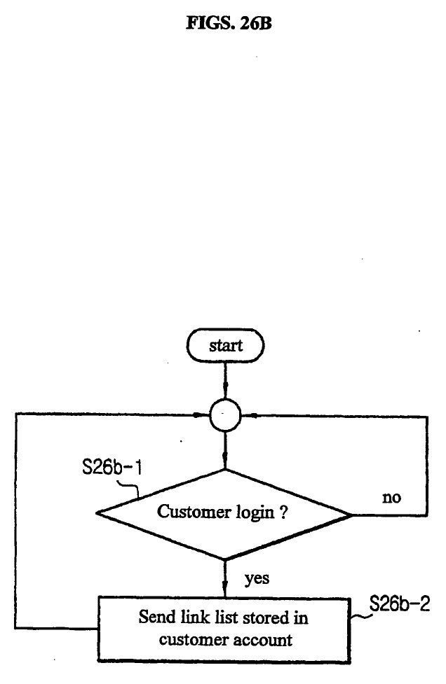

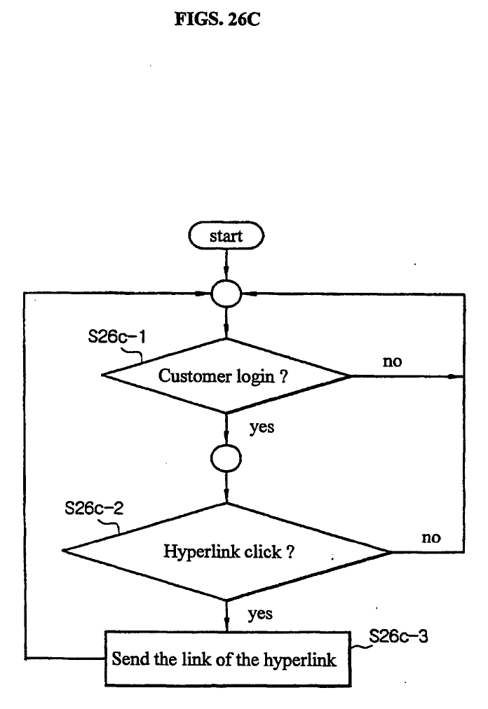

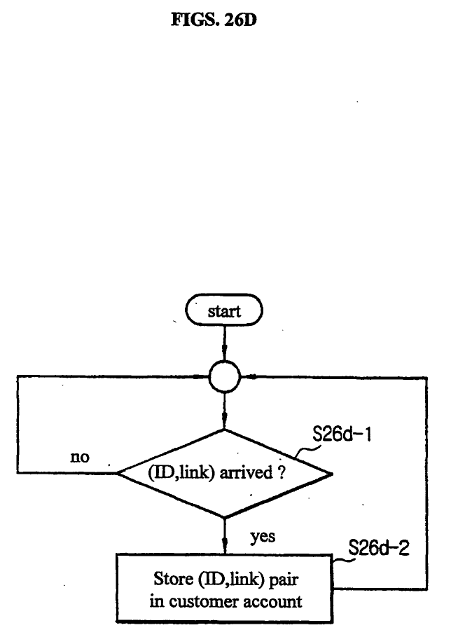

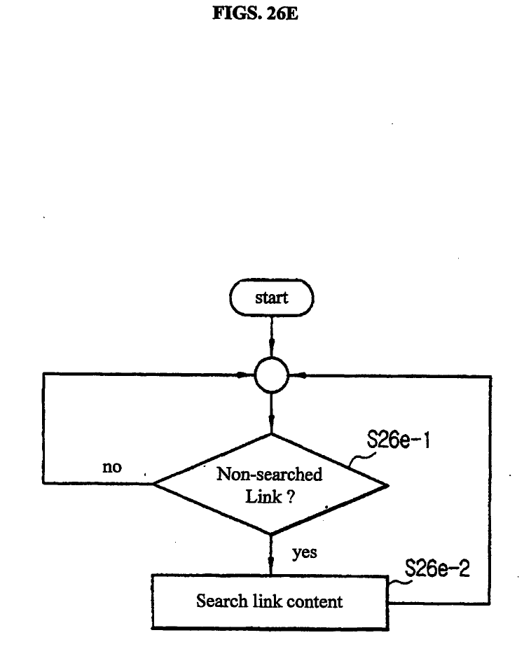

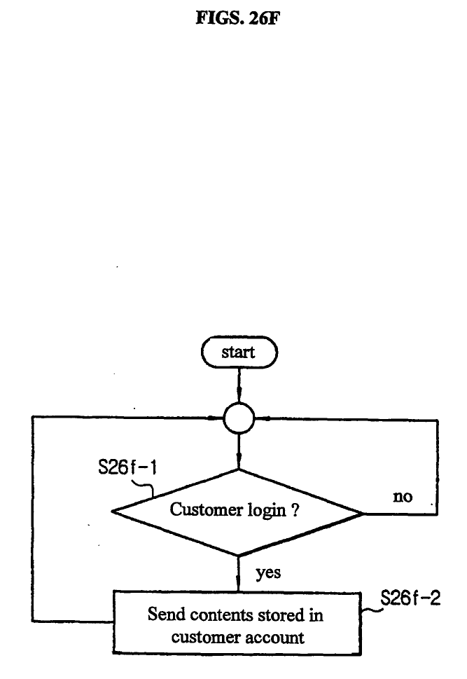

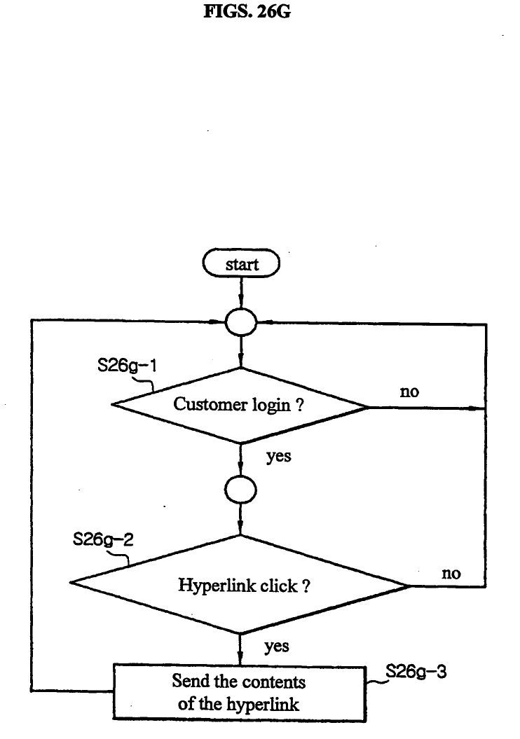

FIG. 26a, FIG. 26b, and FIG. 26c illustrate an embodiment of the present invention wherein customer logs into the electronic information provision server to acquire link information. FIG. 26a is a flow of message reception and link storage task, FIG. 26b is a flow of customer login task and link message transmission task performed simultaneously, and FIG. 26c is a flow of link message transmission task by the hyperlink click activity of logged-in customer.

According to the embodiments illustrated in FIG. 26a, FIG. 261, and FIG. 26c, the electronic information provision server stores (s26a-1, s26a-2) the coupled pair consisting of the customer identification address information and the link information received from the said electronic information gateway. As illustrated in FIG. 26b, the electronic information provision server transmits (s26b-1, s26b-2) the said collected pairs stored for the corresponding customer to the customer network address immediately upon customer login, or alternatively as illustrated in FIG. 26c, the electronic information provision server presents (s26c-1, s26c-2) hyperlinks to the said collected pairs stored for the corresponding customer upon customer login and transmits (s26c-3) one of such pairs to the customer network address when the customer clicks the corresponding hyperlink.

FIG. 26d, FIG. 26e, FIG. 26f, and FIG. 26g illustrate an embodiment of the present invention wherein customer logs into the electronic information provision server to acquire contents information. FIG. 26d is a flow of message reception and link storage task, FIG. 26e is a flow of content search task, FIG. 26f is a flow of customer login task and content message transmission task performed simultaneously, and FIG. 26g is a flow of content message transmission task by the hyperlink click activity of logged-in customer.

According to the embodiments illustrated in FIG. 26d, FIG. 26e, FIG. 26f, and FIG. 26g, the electronic information provision server, as illustrated in FIG. 26d, stores (s26d-1, s26d-2) the coupled pair consisting of the customer identification address information and the link information received from the said electronic information gateway. As illustrated in FIG. 26e, the electronic information provision server searches, retrieves, and stores (s26e-1, s26e-2) contents that are represented by the said link information, utilizing non-busy computing time of the server. As illustrated in FIG. 26f, the electronic information provision server transmits (s26f-1, s26f-2) the collected contents stored for the corresponding customer to the customer network address immediately upon customer login, or alternatively as illustrated in FIG. 26g, the electronic information provision server presents (s26g-1, s26g-2) hyperlinks to the said collected contents stored for the corresponding customer upon customer login and transmits (s26g-3) one of such contents to the customer network address when the customer clicks the corresponding hyperlink.

The method and apparatus for obtaining personal access information and delivering information in electronic form using the obtained personal access information of the present invention described in the invention disclosure maximizes exposure opportunities of advertisement and informational contents in the physical real space and provides a means to acquire electronic information in the physical space as well as in the cyber space. Hence, the present invention increases and enhances values of advertisement and informational contents in the physical space.

In addition, the present invention provides a means of expressing intention to acquire electronic information in the physical space as in cyber space and provides a path leading to procurement of products and service using electronic commerce. Hence, the present invention activates electronic commerce initiated at the physical contacts to physical advertisement and informational contents in the physical space and enhances the benefits of electronic commerce including reduce storage or logistic cost.

Moreover, in the case of theft of storage media such as cards and tags and customer portable information device, the third party that obtains the media or the device is not able to acquire electronic information because the third party cannot modify the network access information therein. Hence, the media or device is safe from malicious use even in case of theft. Because the present invention presents a means to express information acquisition intention in a very private and convenient way and in a short time, it also provides customers with the benefit of privacy and anonymity in particular on the customer behavior related to product procurement.

Unlike prior arts such as Cooltown whose information flow is from beacon devices to portable information device, the present invention provides the information flow from portable storage means to the electronic information gateway apparatus. In the present invention, customer network identification or access information is transmitted to the electronic information gateway and the desired more detailed information is delivered to the customer in a decoupled manner via messaging means such as electronic mails in the Internet. Hence, when using the method of information flow provided by the present invention, customer's possession and carriage of portable information devices or storage devices that stores received data from the information gateway devices such as the beacon devices are not mandated in acquiring information. Only lightweight storage and identification means such as smartcard, REID tag, user beacons, and bodily information is required. Also, the present invention does not mandate any additional device that is required to retrieve collected and stored information in portable information device or storage. Thanks to the method of information flow provided by the present invention, even a small device such as the smartcard reader device is not required. All collected information will be accessed through network where information was directed. Hence, customers can access those information at any place they have access to electronic mails and the Internet.

The present invention also provides the benefit of utilizing existing infrastructure such as the existing smartcard infrastructure. As a result the infrastructural cost is very much reduced in constructing information acquisition system in physical real places.

The present invention also offers device-agnostic operation between heterogeneous devices, because smartcards and tags can be easily attached to the existing devices and the present invention eliminates the need for physical or electrical connection between the smartcards/tags and the device. Prior arts have the disadvantage of modifying existing software and hardware of the existing portable information devices.

As an additional result of the elimination of the physical or electrical connection between smartcards/tags and portable information devices, it is possible to make RFID tags such as smartcards and tags in a sticker form to attach any convenient personal effects. Customers can attach RFID tags to the most convenient and appropriate personal effects to use it as a means of information acquisition in the physical real world.

1. An electronic information gateway module comprising:
a communication means for exchanging data with other devices;
a storage means for storing unique identifiers of objects exposed in the physical real world that can be recognized by servers on network;
a signal reception means for receiving signals from a plurality of portable storage means and extract data from the potable storage means; and
a control means for associating the extracted data from the signal reception means and the identifier stored in the storage means and transmitting to the outside network via the communication means.

2. The electronic information gateway module of claim 1, wherein the control means associates the extracted data with the object identifier, stores them in the storage means, and transmits the associated information via the communication means either upon request from outside through the communication means, or the signal reception means, or on a periodic basis.

3. The electronic information gateway module of claim 1, wherein the data extracted from the signal reception means comprises network access information by which customer is uniquely identified and accessed in one or more networks.

4. The electronic information gateway module of claim 3, wherein the network access information is an electronic mail address of a customer.

5. The electronic information gateway module of claim 3, wherein the network access information is a unique customer ID consisting of alphanumeric and a limit set of special characters.

6. The electronic information gateway module of claim 1, wherein the data extracted from the signal reception means comprises short messaging service (SMS) address information which uniquely identifies a personal portable device or an electronic information providing server and by which transmits messages to the device or the server.

7. The electronic information gateway module of claim 1, wherein the information extracted by the signal reception means comprises bio or bodily information or digital signature of a customer.

8. The electronic information gateway module of claim 1, wherein the information extracted by the signal reception means comprises data that identifies customer's payment information or data that identifies customer's payment information stored in the information providing server.

9. The electronic information gateway module of claim 1, wherein the object identification information comprises the Uniform Resource Locator (URL) consisting of protocol type, site address, and directory path.

10. The electronic information gateway module of claim 1, wherein the storage means additionally stores the unique identifier of the apparatus that identifies one apparatus from others and the control means transmits the stored apparatus identifier together with other information stored in the storage means via the communication means.

11. The electronic information gateway module of claim 1, wherein the signal reception means transmits waves to the portable storage media and receives signals that the portable storage means transmits without physical contacts to the portable storage means.

12. The electronic information gateway module of claim 1, wherein the signal reception means acquires signal data from the portable storage media via electronic and/or physical contacts to the portable storage means.

13. An electronic information gateway module comprising:
a communication means which exchanges data with other devices;
a storage means which stores information on at least one objects that are exposed to outside and identifiers that represent and point to the information which is received via the communication means;
a presentation means which presents one or more electronic information stored in the storage means in human understandable formats;
a signal reception means which receives signals from a plurality of portable storage means and extract data from them; and
a control means that associates the extracted data from the signal reception means and the identifier stored in the storage means and transmits them to the outside network via the communication means.

14. The electronic information gateway module of claim 13, wherein the control means associates the extracted data with the identifier to electronic information, stores them in the storage means, and transmits the associated information via the communication means either upon request from outside through the communication means or the signal reception means, or on a periodic basis.

15. The electronic information gateway module of claim 13, wherein plurality of electronic information is successively exposed to outside in human recognized and understandable formats, following predefined or random sequences and following predefined time periods.

16. The electronic information gateway module of claim 13, wherein the extracted data by the signal reception means comprises information by which customer is identified uniquely and accessed in at least one networks.

17. The electronic information gateway module of claim 16, wherein the network access information is an electronic mail address of a customer.

18. The electronic information gateway module of claim 16, wherein the network access information is a unique customer ID consisting of alphanumeric and a limit set of special characters.

19. The electronic information gateway module of claim 13, wherein data extracted from the signal reception means comprises short messaging service (SMS) address information which uniquely identifies a personal portable device or electronic information providing server and by which transmits messages to the device or server.

20. The electronic information gateway module of claim 19, wherein the electronic information comprises presentation information that is exposed to outside and summary information that is provided at the point of customer's contact and the control means provides the summary information as a part of the electronic information as well as the identification information to outside and to customer's portable information devices via the communication means.

21. The electronic information gateway module of claim 20, wherein the summary information is price information such as price or fee of the product or service represented by exposed objects.

22. The electronic information gateway module of claim 13, wherein the information extracted by the signal reception means comprises bio or bodily information or digital signature of customers.

23. The electronic information gateway module of claim 13, wherein the information extracted by the signal reception means comprises data that identifies customer's payment information or data that identifies customer's payment information stored in the information providing server.

24. The electronic information gateway module of claim 13, wherein the object identification information comprises a Uniform Resource Locator (URL) consisting of protocol type, site address, and directory path.

25. The electronic information gateway module of claim 13, wherein the storage means additionally stores the unique identifier of the apparatus that identifies one apparatus from others and the control means transmits the stored apparatus identifier together with other information stored in the storage means via the communication means.

26. The electronic information gateway module of claim 13, wherein the signal reception means transmits waves to the portable storage media and receives signals that the portable storage means transmits without physical contacts to the portable storage means.

27. The electronic information gateway module of claim 13, wherein the signal reception means acquires signal data from the portable storage media via electronic and/or physical contacts to the portable storage means.

28. The electronic information gateway module of claim 13, wherein the contents of the electronic information are the advertisement of product, service, and corporate image.

29. An electronic information gateway module comprising:
a communication means which exchanges data with other devices;
a storage means which stores information on one or more objects that are exposed to outside and identifiers that represent or point to the information which is received via the communication means;
a presentation means which presents one or more electronic information stored in the storage means in human understandable formats; and
a transmission means that transmits an identifier of the electronic information that is currently being presented on the presentation means to portable information devices.

30. The electronic information gateway module of claim 29, wherein the storage means additionally stores a unique identifier of an apparatus that identifies one apparatus from others and the transmission means transmits the stored apparatus identifier together with the electronic information identifier.

31. The electronic information gateway module of claim 29, wherein the electronic information comprises presentation information that is exposed to outside and summary information that is provided at the point of customer's contact and the transmission means provides the summary information as a part of the electronic information as well as the identification information to portable information devices.

32. The electronic information gateway module of claim 31, wherein the summary information is price information such as price or fee of the product or service represented by exposed objects.

33. An electronic information gateway module comprising:
a communication means which exchanges data with other devices;
a storage means which stores information on at least one objects that are exposed to outside and identifiers that represent and point to the information, or identifiers that represent and point to the objects uniquely in the real physical spaces;
a presentation means which presents one or more electronic information stored in the storage means in human understandable formats;
a signal reception means which receives signals from portable storage means and extract data from them; and
a control means that transmits either one of the extracted data from the signal reception means, the identifier of the electronic information currently being presented, and the identifier of object represented by the electronic information or transmits their combinations by associating plurality of them, to the outside via the communication means.

34. The electronic information gateway module of claim 33, wherein further comprises keying input means that accepts alphanumeric or a limited set of special characters, wherein the electronic information in the storage means, identifier of the electronic information, and the object identifier are designated by input key values.

35. The electronic information gateway module of claim 33, wherein the control means associates the extracted data with the electronic information identifier or with the object identifier and stores them in the storage means, and transmits the associated information to the outside via the communication means either upon request from outside through the communication means or the signal reception means, or on a periodic basis.

36. The electronic information gateway module of claim 33, wherein plurality of electronic information are successively exposed to outside in human recognized and understandable formats, following predefined or random sequences and following predefined time periods.

37. The electronic information gateway module of claim 33, wherein the extracted data by the signal reception means comprises information by which a customer is identified uniquely and accessed in one or more networks.

38. The electronic information gateway module of claim 37, wherein the network access information is electronic mail address of a customer.

39. The electronic information gateway module of claim 37, wherein the network access information is a unique customer ID consisting of alphanumeric and a limit set of special characters.

40. The electronic information gateway module of claim 33, wherein the communication means exchanges data signal wirelessly with remote signal concentration apparatus.

41. The electronic information gateway module of claim 40, wherein data extracted from the signal reception means comprises short messaging service (SMS) address information which uniquely identifies a personal portable device or an electronic information providing server and by which transmits messages to the device or server.

42. The electronic information gateway module of claim 41, wherein the electronic information comprises presentation information that is exposed to outside and summary information that is provided at the point of customer's contact and the control means provides the summary information as a part of the electronic information as well as the identification information to outside and to customer's portable information devices via the communication means.

43. The electronic information gateway module of claim 42, wherein the summary information is price information such as price or fee of the product or service represented by exposed objects.

44. The electronic information gateway module of claim 33, wherein the information extracted by the signal reception means comprises bio or bodily information or digital signature of customers.

45. The electronic information gateway module of claim 33, wherein the information extracted by the signal reception means comprises data that identifies customer's payment information or data that identifies customer's payment information stored in the information providing server.

46. The electronic information gateway module of claim 33, wherein the object identification information comprises a Uniform Resource Locator (URL) consisting of protocol type, site address, and directory path.

47. The electronic information gateway module of claim 33, wherein the storage means additionally stores a unique identifier of an apparatus that identifies one apparatus from others and the control means transmits the stored apparatus identifier together with other information stored in the storage means via the communication means.

48. The electronic information gateway module of claim 33, wherein the signal reception means transmits waves to the portable storage media and receives signals that the portable storage means transmits without physical contacts to the portable storage means.

49. The electronic information gateway module of claim 33, wherein the signal reception means acquires signal data from the portable storage media via electronic and/or physical contacts to the portable storage means.

50. The electronic information gateway module of claim 33, wherein the contents of the electronic information are the advertisement of product, service, and corporate image.

51. An electronic information gateway module comprising:
a storage means which stores one or more electronic information on objects exposed to the outside and more detailed information that is related to the information but is not exposed to the outside;
a presentation means which presents one or more electronic information stored in the storage means in human understandable formats; and
a transmission means that reads from the storage means more detailed version of information of the electronic information that is currently begin presented on the presentation means and transmits the more detailed version of information to portable information devices.

52. The electronic information gateway module of claim 51, wherein the storage means additionally stores identifiers of at least one electronic information and the transmission means transmits the identifiers together with the more detailed information of the electronic information that is being presented upon customer contact.

53. The electronic information gateway module of claim 52, wherein the electronic information identifier comprises the Uniform Resource Locator (URL) consisting of protocol type, site address, and directory path.

54. The electronic information gateway module of claim 51, wherein the storage means contains disk drive media that stores the electronic information and more detailed information and disk drive device that reads data from the disk drive media.

55. An electronic information providing apparatus for acquisition of customer access address information and for provision of electronic information to the acquired access address, which comprises:
an electronic information gateway module presenting at least one stored electronic information to outside in a human understandable format and transmitting via connected network the identifier of the electronic information presented to outside upon customer contact together with the received customer identification data which is received from proximity or contact type portable storage means; and
an electronic information providing server receiving the customer identification data and the electronic information identifier, acquiring network access information of a customer from the customer identification data, acquiring more detailed information of the electronic information from the electronic information identifier, and transmitting the acquired more detailed information to the acquired network access information as destination via the network and separate networks.

56. The electronic information providing apparatus for acquisition of customer access address information and for provision of electronic information to the acquired access address of claim 55, wherein the electronic information gateway acquires at least one stored electronic information from the electronic information providing server via the network.

57. The electronic information providing apparatus for acquisition of customer access address information and for provision of electronic information to the acquired access address of claim 55, further comprising an electronic information forwarding apparatus receiving data signal from connected plurality of the electronic information gateway modules wired or wirelessly, packetizing and transmitting the data to the electronic information providing server via the network, receiving data via the network electronic information providing server, locating corresponding electronic information gateway modules out of plurality of the gateways, optionally reformating the received data, and transmitting and distributing the received data to the corresponding electronic information gateway modules.

58. The electronic information providing apparatus for acquisition of customer access address information and for provision of electronic information to the acquired access address of claim 55, wherein the electronic information providing server acquires more detailed version of the electronic information by searching using other search server for transmission.

59. The electronic information providing apparatus for acquisition of customer access address information and for provision of electronic information to the acquired access address of claim 55, wherein the more detailed version of electronic information comprises electronic order form of products and services that are represented or advertised by the electronic information.

60. The electronic information providing apparatus for acquisition of customer access address information and for provision of electronic information to the acquired access address of claim 59, wherein the electronic information providing server receives the electronic order form filled with ordering information and transmits the order form to one or more electronic commerce servers for order processing.

64. The electronic information providing apparatus for acquisition of customer access address information and for provision of electronic information to the acquired access address of claim 60, wherein the electronic information providing server receives the electronic order form filled with ordering information and transmits customer's payment information registered therein such as credit card or bank account information together with the order form to one or more electronic commerce servers for order processing.

62. The electronic information providing apparatus for acquisition of customer access address information and for provision of electronic information to the acquired access address of claim 59, wherein the electronic information providing server records the time of reception when it receives again the customer identifier and the electronic information identifier, and transmits the received electronic order from to outside electronic commerce server based on the result of time comparison, when the transmitted electronic order form is received again with information on the time in which customer expressed intention to acquire more detailed version of electronic information.

63. The electronic information providing apparatus for acquisition of customer access address information and for provision of electronic information to the acquired access address of claim 59, wherein the electronic information providing server stores the identification information of electronic information gateway when it receives customer identifier and electronic information identifier together with the identifier of the electronic information gateway, and transmits the received electronic order from to outside electronic commerce server if the stored gateway identifier matches the gateway identifier included in the electronic order form received again.

64. The electronic information providing apparatus for acquisition of customer access address information and for provision of electronic information to the acquired access address of claim 55, wherein the electronic information providing server provides the customer identified by the customer identification information with accumulated points to electronic coupons for discounted product and service prices when the customer submits cyber money used in electronic commerce or its identification information.

65. An electronic information providing apparatus for acquisition of customer access address information and for provision of electronic information to the acquired access address, which comprises:
an electronic information gateway module presenting at least one stored electronic information to outside in a human understandable format and transmitting via connected network an identifier of the electronic information presented to outside upon customer contact together with a bio-informatics or the bodily identification data of the customer extracted by proximity or contact type sensors; and
an electronic information providing server receiving the bio-informatics or bodily identification data and the electronic information identifier, identifying the customer by comparing the received data with the stored bio-informatics or the bodily identification data, acquiring network access information of the customer from the stored repository, and transmitting the more detailed version of the electronic information to the acquired network access information as the destination via the network and separate networks.

66. The electronic information providing apparatus for acquisition of customer access address information and for provision of electronic information to the acquired access address of claim 65, wherein the electronic information identifier comprises the Uniform Resource Locator (URL) consisting of protocol type, site address, and directory path.

67. An electronic information providing apparatus for acquisition of customer access address information and for provision of electronic information to the acquired access address, which comprises:
an electronic information gateway module presenting at least one stored electronic information to outside in a human understandable format and transmitting an identifier of the electronic information presented to outside upon customer contact to a portable information devices when they approaches to or make contacts with the gateway module; and
an electronic information providing server receiving from the portable information devices the electronic information identifier and the customer identification information stored therein, extracting the network access information of the customer from the received customer identification information, and transmitting the more detailed version of the electronic information to the acquired network access information as the destination via the network and separate networks.

68. The electronic information providing apparatus for acquisition of customer access address information and for provision of electronic information to the acquired access address of claim 67, wherein the electronic information identifier comprises the Uniform Resource Locator (URL) consisting of protocol type, site address, and directory path.

69. The electronic information providing apparatus for acquisition of customer access address information and for provision of electronic information to the acquired access address of claim 68, wherein the electronic information providing server is a separate server serving information represented by the URL and the electronic information providing module transmits the more detailed version of the electronic information to the portable information device by switching data communication path to the device that is connected at the point of customer contact.

70. A method of providing electronic information for acquisition of customer access address information and for provision of electronic information to the acquired access address, comprising the steps of:
(a1) acquiring data out of signals received from a portable storage media while having the electronic information representing real world objects identified by the network server providing more detailed version of the information on an object exposed in real, physical world;
(a2) constructing a message by acquiring network identification and access information from the extracted data and by including the pre-stored electronic information on the objects; and
(a3) transmitting the constructed messages via network to the network access information as destinations.

71. The method of providing electronic information for acquisition of customer access address information and for provision of electronic information to the acquired access address of claim 70, wherein in the step (a2), the message is constructed by associating pre-stored the object identification information with the acquired network access information.

72. The method of providing electronic information for acquisition of customer access address information and for provision of electronic information to the acquired access address of claim 70, wherein the step (a2) of constructing the message further comprises the following step:
(a21) acquiring additional information on the object from the stored object identification information, and wherein the message is constructed by coupling the network access information and the acquired additional information.

73. The method of providing electronic information for acquisition of customer access address information and for provision of electronic information to the acquired access address of claim 71, wherein the step (a3) comprises the following steps:
(a31) storing messages constructed by coupling the access information and the additional information are stored; and
(a32) transmitting message interpreted and transmitted periodically or upon request from outside by sensing elapsed time since last transmission or by sensing such outside requests.

74. A method of providing electronic information for acquisition of customer access address information and for provision of electronic information to the acquired access address, comprising the steps of:
(b1) acquiring data out of signals from a portable storage media while having the electronic information representing real world objects identified by the network server providing more detailed version of the information on the object exposed in real, physical world;
(b2) constructing a message by acquiring network identification and access information from the extracted data and by including the pre-stored electronic information on the objects;
(b3) transmitting the message to the electronic information providing server that provides more detailed information on the object; and
(b4) transmitting the message by the electronic information providing server via network to the network access information as destinations.

75. The method of providing electronic information for acquisition of customer access address information and for provision of electronic information to the acquired access address of claim 74, wherein in the step (b2), the message is constructed by associating pre-stored the object identification information with the acquired network access information.

76. The method of providing electronic information for acquisition of customer access address information and for provision of electronic information to the acquired access address of claim 74, wherein the step (b4) comprises storing the received message into the storage area associated with the customer account and transmitting the at least one stored message to the customer who logs into the system afterwards.

77. The method of providing electronic information for acquisition of customer access address information and for provision of electronic information to the acquired access address of claim 74, wherein the step (b4) further comprises the following steps:
(b41) acquiring additional information on the object, extracted from the received message; wherein the step (b4) the acquired additional information is transmitted together with the message.

78. A method of providing electronic information for acquisition of customer access address information and for provision of electronic information to the acquired access address, comprising the steps of:
(c1) storing at least one information on the object presented to outside and its identifiers;
(c2) extracting data out of signals with checking the signals from a portable storage means, while the stored electronic information being presented in sequence in a pre-configured time period;
(c3) constructing a message by associating the network identification and access information acquired from the extracted data and the extracted electronic information identifier that represents electronic information presented at the time of customer contact; and
(c4) transmitting the constructed messages via network to the network access information as destinations.

79. The method of providing electronic information for acquisition of customer access address information and for provision of electronic information to the acquired access address of claim 78, wherein the step (c3) further comprises the following step:
(c31) acquiring additional information on the object from the identifier of electronic information that is being presented on the customer contact, and wherein the message is constructed by associating the network access information and the acquired additional information.

80. The method of providing electronic information for acquisition of customer access address information and for provision of electronic information to the acquired access address of claim 78, wherein the step (c4) comprises the following steps:
(c41) storing the messages constructed by coupling the network access information and the electronic information identifier or the additional information; and
(c42) transmitting the messages interpreted and transmitted periodically or upon request from outside by sensing elapsed time since last transmission or by sensing such outside requests.

81. A method of providing electronic information for acquisition of customer access address information and for provision of electronic information to the acquired access address comprising the steps of:
(d1) storing at least one information on the object presented to outside and its identifiers;
(d2) extracting data out of signals with checking the signals from a portable storage means, while the stored electronic information being presented in sequence in a pre-configured time period;
(d3) constructing a message by associating the network identification and access information acquired from the extracted data and the extracted electronic information identifier that represents electronic information presented at the time of customer contact;
(d4) transmitting the message to the electronic information providing server that provides more detailed information on the object; and
(d5) transmitting the message by the electronic information providing server via network to the network access information as destinations.

82. The method of providing electronic information for acquisition of customer access address information and for provision of electronic information to the acquired access address of claim 81, wherein the step (d5) comprises storing the received message into the storage area associated with the customer account and transmitting the at least one stored message to the customer who logs into the system afterwards.

83. The method of providing electronic information for acquisition of customer access address information and for provision of electronic information to the acquired access address of claim 81, wherein the step (d5) further comprises the following step:
(d51) acquiring additional information on the object from the identifier of electronic information that is being presented on the customer contact, and wherein the message is reconstructed by associating the network access information and the acquired additional information.

84. The method of providing electronic information for acquisition of customer access address information and for provision of electronic information to the acquired access address of claim 81, wherein the step (d5) comprises the following steps:
(d52) storing the messages constructed by coupling the network access information and the electronic information identifier or the additional information; and
(d53) transmitting the messages interpreted and transmitted periodically or upon request from outside by sensing elapsed time since last transmission or by sensing such outside requests.

85. A method of providing electronic information for acquisition of customer access address information and for provision of electronic information to the acquired access address comprising the steps of:
(f1) locally transmitting an electronic information identifier of the content presented at the point of customer contact to a portable information device from an electronic information gateway that stores the identifier when the portable information device is contacted or is in close proximity;
(f2) transmitting the electronic information identifier that is collected by the portable information device through one or more (f1) steps to an remote electronic information providing server together with the customer identification information stored in the portable information device;
(f3) acquiring information by extracting customer network access information from the customer identification information which is received by the electronic information providing server and by searching more detailed version of the electronic information from the electronic information identifier; and
(f4) transmitting the acquired detailed version of the electronic information to the acquired network access information as its destination.

86. The method of providing electronic information for acquisition of customer access address information and for provision of electronic information to the acquired access address of claim 85, wherein the electronic information gateway receives the presentation contents from the electronic information providing server and presents them in visible and/or in audible form following a sequence periodically.

87. The method of providing electronic information for acquisition of customer access address information and for provision of electronic information to the acquired access address of claim 85, wherein the presentation contents are presented as objects or their parts which are installed in the physical space or on the surface of other objects such as signs on buildings or on street.
